(19) United States
(12) Patent Application Publication
(10) Pub. No.: US 2026/0170698 A1
(43) Pub. Date: Jun. 18, 2026

(54) HIGH-LEVEL SYNTAX FOR CODING GEOMETRY IN POLYGON MESH COMPRESSION

(71) Applicant: Tencent America LLC, Palo Alto, CA (US)

(72) Inventors: Chao HUANG, Palo Alto, CA (US); Shan LIU, San Jose, CA (US)

(73) Assignee: Tencent America LLC, Palo Alto, CA (US)

(21) Appl. No.: 19/362,117

(22) Filed: Oct. 17, 2025

Related U.S. Application Data
(60) Provisional application No. 63/735,272, filed on Dec. 17, 2024.

(51) Int. Cl. G06T 9/00; H04N 19/70

(52) U.S. Cl. CPC G06T 9/001; H04N 19/70

(57) ABSTRACT

A method for decoding a mesh includes decoding a first syntax element for a first group of connected components of a plurality of groups of connected components in a bitstream. The first syntax element indicates a first geometry coding strategy for coding a geometry of the first group of connected components. The mesh includes a plurality of connected components that is divided into the plurality of groups of connected components based on at least one topological characteristic of each connected component. The first group of connected components has the same at least one topological characteristic. The method for decoding a mesh includes decoding the geometry of the first group of connected components with the first geometry coding strategy that is different from a second geometry coding strategy for a geometry of a second group of connected components in the plurality of groups of connected components.

### INCORPORATION BY REFERENCE

The present application claims the benefit of priority to U.S. Provisional Application No. 63/735,272 filed on Dec. 17, 2024. The entire disclosure of the prior application is hereby incorporated by reference.

### TECHNICAL FIELD

The present disclosure describes aspects generally related to mesh processing.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

Advances in three-dimensional (3D) capture, modeling, and rendering have promoted 3D content across various platforms and devices. For example, a baby's first step in one continent is captured and grandparents may see (and in some cases interact) and enjoy a full immersive experience with the child in another continent. In order to achieve such realism, models are becoming more sophisticated, and a significant amount of data is linked to the creation and consumption of those models. 3D meshes are widely used to represent such immersive contents.

### SUMMARY

Aspects of the disclosure include methods and apparatuses for mesh processing.

Aspects of the disclosure include a method for decoding a mesh. The method for decoding a mesh includes decoding a first syntax element for a first group of connected components of a plurality of groups of connected components in a bitstream. The first syntax element indicates a first geometry coding strategy for coding a geometry of the first group of connected components. The mesh includes a plurality of connected components that is divided into the plurality of groups of connected components based on at least one topological characteristic of each connected component. The first group of connected components having the same at least one topological characteristic. The method for decoding a mesh includes decoding the geometry of the first group of connected components with the first geometry coding strategy that is different from a second geometry coding strategy for a geometry of a second group of connected components in the plurality of groups of connected components.

Aspects of the disclosure also provide an apparatus for mesh decoding. The apparatus for mesh decoding including processing circuitry configured to implement any of the described methods including the method for decoding performed in a decoder.

In an aspect, a method for encoding a mesh is provided. The method for encoding the mesh includes dividing a plurality of connected components in the mesh into a plurality of groups of connected components based on at least one topological characteristic of each connected component and encoding a geometry of a first group of connected components in the plurality of groups of connected components with a first geometry coding strategy that is different from a second geometry coding strategy for coding a geometry of a second group of connected components in the plurality of groups of connected components. The first group of connected components has the same at least one topological characteristic. The method for encoding the mesh includes encoding, in a bitstream, a first syntax element for the first group of connected components. The first syntax element indicates the first geometry coding strategy.

Aspects of the disclosure also provide an apparatus for mesh encoding. The apparatus for mesh encoding including processing circuitry configured to implement any of the described methods of mesh processing such as the method for encoding the mesh performed in an encoder.

In some aspects, the techniques described herein relate to a non-transitory computer readable medium storing a video media bitstream encoded by an encoding method, the encoding method including: dividing a plurality of connected components in the mesh into a plurality of groups of connected components based on at least one topological characteristic of each connected component; encoding a geometry of a first group of connected components in the plurality of groups of connected components with a first geometry coding strategy that is different from a second geometry coding strategy for coding a geometry of a second group of connected components in the plurality of groups of connected components; and encoding, in a bitstream, a first syntax element for the first group of connected components. The first syntax element indicates the first geometry coding strategy. The first group of connected components has the same at least one topological characteristic;

Aspects of the disclosure also provide a non-transitory computer-readable medium storing instructions which, when executed by a computer, cause the computer to perform any of the described methods for mesh processing.

Technical solutions of the disclosure include dividing or grouping a plurality of connected components in a mesh into a plurality of groups of connected components based on at least one topological characteristic of each connected component and coding different groups of connected components with different geometry coding strategies. Further, the geometry coding strategy for a group of connected components is signaled at a high-level (e.g., a slice level which corresponds to the group of connected components). In some examples, different groups of connected components in the mesh benefit from different geometry coding strategies depending on the characteristics. Thus, coding different groups of connected components with different geometry coding strategies as described in the disclosure results in better coding efficiencies and is more adaptive.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of an encoding process for mesh processing based on a related video codec according to an aspect of the disclosure.

FIG. 5 shows an example of a decoding process for mesh processing according to an aspect of the disclosure.

FIG. 6 shows an example of a vertex degree of a vertex and a face degree of a face of a mesh according to an aspect of the disclosure.

FIG. 7 shows an example of a primal mesh and a dual mesh according to an aspect of the disclosure.

FIGS. 8-9 show an example of a traversal sequence of a dual-degree algorithm according to an aspect of the disclosure.

FIG. 10 shows an example of a polygon-fan according to an aspect of the disclosure.

FIG. 11 shows an example of topological configurations C0-C8 used to compress a triangle-fan connectivity according to an aspect of the disclosure.

FIG. 12 shows an example of compatible orientations according to an aspect of the disclosure.

FIG. 13 shows an example of incompatible orientations according to an aspect of the disclosure.

FIG. 14A shows an example of a closed face-fan around a vertex V1 in a manifold according to an aspect of the disclosure.

FIG. 14B shows an example of an open face-fan around a vertex V2 in a manifold according to an aspect of the disclosure.

FIG. 14C shows an example of more than one face-fan around a vertex V3 in a non-manifold according to an aspect of the disclosure.

FIG. 14D shows an example of more than one face-fan around a vertex V4 in a non-manifold according to an aspect of the disclosure.

FIG. 14E shows an example of more than one face-fan around a vertex V5 in a non-manifold according to an aspect of the disclosure.

FIG. 15 shows a flow chart outlining a decoding process according to some aspects of the disclosure.

FIG. 16 shows a flow chart outlining an encoding process according to some aspects of the disclosure.

FIG. 17 is a schematic illustration of a computer system in accordance with an aspect.

### DETAILED DESCRIPTION

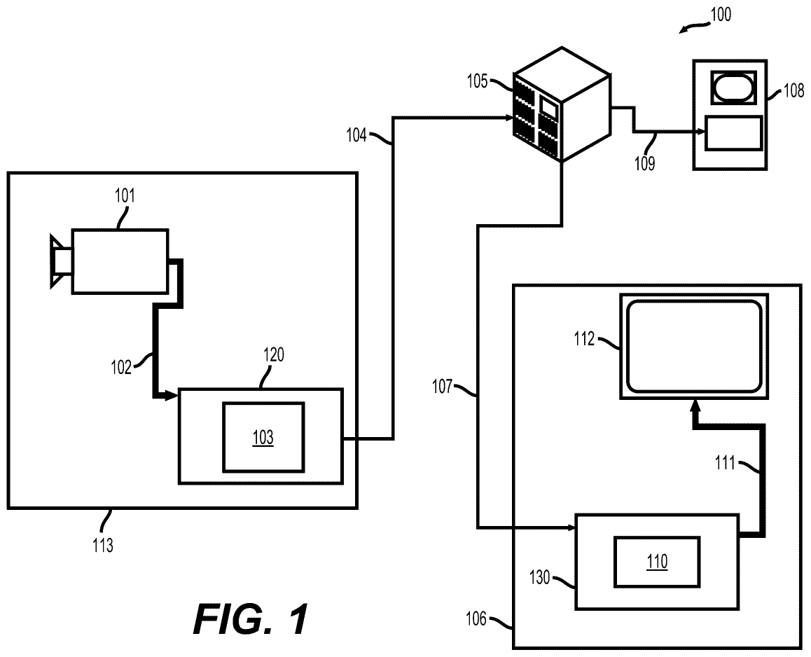

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other image and/or video enabled applications, including, for example, video conferencing, digital TV, streaming services, storing of compressed video on digital media including CD, DVD, memory stick, and the like.

The video processing system (100) includes a capture subsystem (113), that may include a video source (101). The video source (101) may include one or more images captured by a camera and/or generated by a computer. For example, a digital camera may create a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) may be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) may include other components (not shown). For example, the electronic device (120) may include a video decoder (not shown) and the electronic device (130) may include a video encoder (not shown) as well.

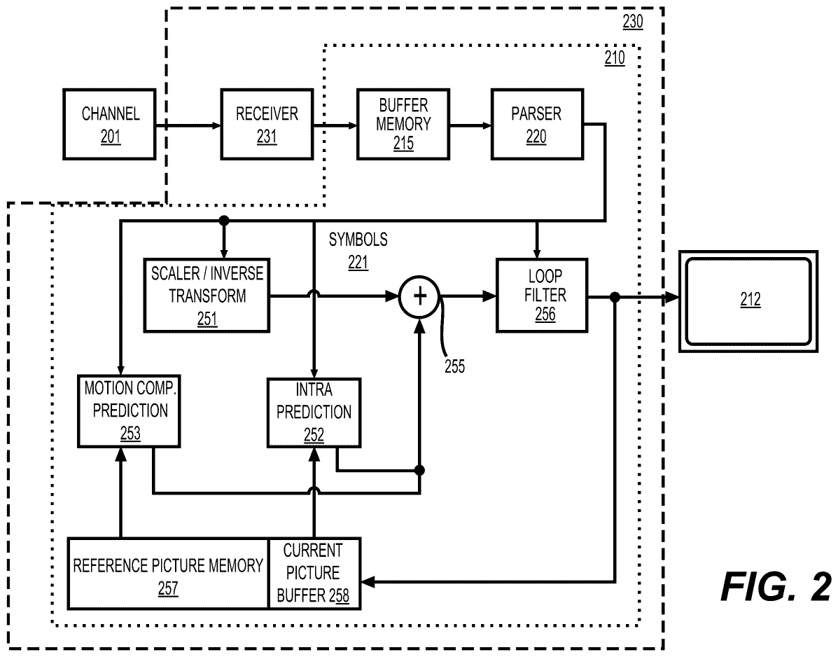

FIG. 2 shows an example of a block diagram of a video decoder (210). The video decoder (210) may be included in an electronic device (230). The electronic device (230) may include a receiver (231). The receiver (231) may include receiving circuitry, such as network interface circuitry. The video decoder (210) may be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it may be outside of the video decoder (210) (not depicted). In still others, there may be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or may be small. For use on best effort packet networks such as the Internet, the buffer memory (215) may be required, may be comparatively large and may be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but may be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence may be in accordance with a video coding technology or standard, and may follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups may include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) may involve multiple different units depending on the type of the coded video picture or parts thereof (such as: inter and intra picture, inter and intra block), and other factors. Which units are involved, and how, may be controlled by subgroup control information parsed from the coded video sequence by the parser (220). The flow of such subgroup control information between the parser (220) and the multiple units below is not depicted for clarity.

Beyond the functional blocks already mentioned, the video decoder (210) may be conceptually subdivided into a number of functional units as described below. In a practical implementation operating under commercial constraints, many of these units interact closely with each other and may, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) may output blocks comprising sample values, that may be input into aggregator (255).

In some cases, the output samples of the scaler/inverse transform unit (251) may pertain to an intra coded block. The intra coded block is a block that is not using predictive information from previously reconstructed pictures, but may use predictive information from previously reconstructed parts of the current picture. Such predictive information may be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) may pertain to an inter coded, and potentially motion compensated, block. In such a case, a motion compensation prediction unit (253) may access reference picture memory (257) to fetch samples used for prediction. After motion compensating the fetched samples in accordance with the symbols (221) pertaining to the block, these samples may be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples may be controlled by motion vectors, available to the motion compensation prediction unit (253) in the form of symbols (221) that may have, for example X, Y, and reference picture components. Motion compensation also may include interpolation of sample values as fetched from the reference picture memory (257) when sub-sample exact motion vectors are in use, motion vector prediction mechanisms, and so forth.

The output samples of the aggregator (255) may be subject to various loop filtering techniques in the loop filter unit (256). Video compression technologies may include in-loop filter technologies that are controlled by parameters included in the coded video sequence (also referred to as coded video bitstream) and made available to the loop filter unit (256) as symbols (221) from the parser (220). Video compression may also be responsive to meta-information obtained during the decoding of previous (in decoding order) parts of the coded picture or coded video sequence, as well as responsive to previously reconstructed and loop-filtered sample values.

The output of the loop filter unit (256) may be a sample stream that may be output to the render device (212) as well as stored in the reference picture memory (257) for use in future inter-picture prediction.

Certain coded pictures, once fully reconstructed, may be used as reference pictures for future prediction. For example, once a coded picture corresponding to a current picture is fully reconstructed and the coded picture has been identified as a reference picture (by, for example, the parser (220)), the current picture buffer (258) may become a part of the reference picture memory (257), and a fresh current picture buffer may be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile may select certain tools as the only tools available for use under that profile from all the tools available in the video compression technology or standard. Also necessary for compliance may be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels may, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data may be in the form of, for example, temporal, spatial, or signal noise ratio (SNR) enhancement layers, redundant slices, redundant pictures, forward error correction codes, and so on.

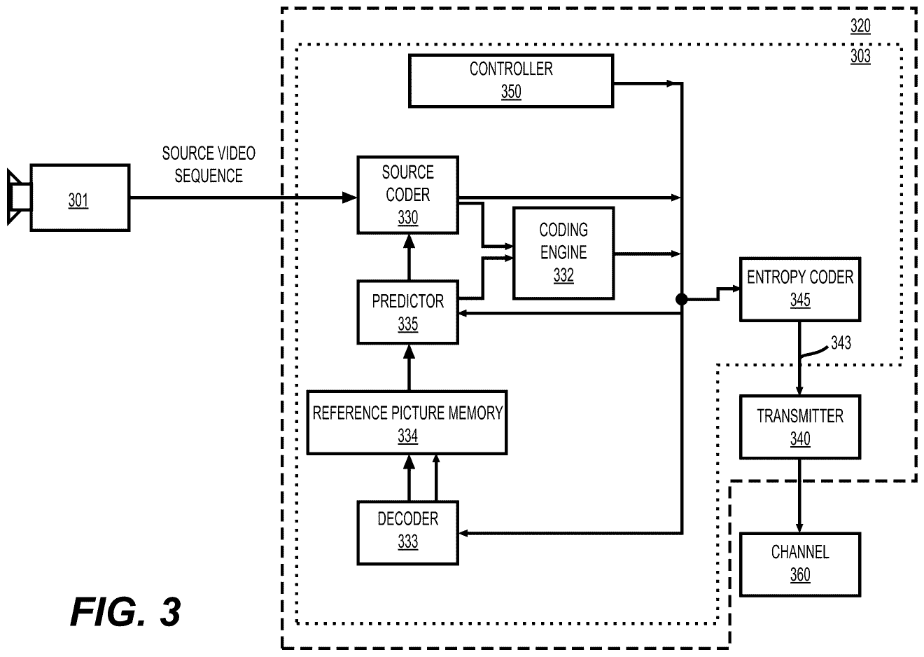

FIG. 3 shows an example of a block diagram of a video encoder (303). The video encoder (303) is included in an electronic device (320). The electronic device (320) includes a transmitter (340) (e.g., transmitting circuitry). The video encoder (303) may be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that may be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel may include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) may include rate control related parameters (picture skip, quantizer, lambda value of rate-distortion optimization techniques, . . . ), picture size, group of pictures (GOP) layout, maximum motion vector search range, and so forth. The controller (350) may be configured to have other suitable functions that pertain to the video encoder (303) optimized for a certain system design.

In some aspects, the video encoder (303) is configured to operate in a coding loop. As an oversimplified description, in an example, the coding loop may include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity may not be maintained, for example because of channel errors) is used in some related arts as well.

The operation of the “local” decoder (333) may be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) may be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies may be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using at most one motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures may use more than two reference pictures and associated metadata for the reconstruction of a single block.

Aspect of the present disclosure may also be applied to variants of I pictures, P pictures, and B pictures, and their respective applications and features.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture may be coded by a vector that is referred to as a motion vector. The motion vector points to the reference block in the reference picture, and may have a third dimension identifying the reference picture, in case multiple reference pictures are in use.

In some aspects, a bi-prediction technique may be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture may be coded by a first motion vector that points to a first reference block in the first reference picture, and a second motion vector that points to a second reference block in the second reference picture. The block may be predicted by a combination of the first reference block and the second reference block.

Further, a merge mode technique may be used in the inter-picture prediction to improve coding efficiency.

According to some aspects of the disclosure, predictions, such as inter-picture predictions and intra-picture predictions, are performed in the unit of blocks, such as a polygon-shaped or triangular block. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU may be recursively quadtree split into one or multiple coding units (CUs). For example, a CTU of 64×64 pixels may be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) may be implemented using any suitable technique. In an aspect, the video encoders (103) and (303) and the video decoders (110) and (210) may be implemented using one or more integrated circuits. In another aspect, the video encoders (103) and (303), and the video decoders (110) and (210) may be implemented using one or more processors that execute software instructions.

A mesh (e.g., a polygon mesh) may include a plurality of polygons (such as a plurality of polygonal faces) that may describe a surface of a volumetric object. For example, the surface of the volumetric object may be approximated using the mesh. Each polygon of the mesh may be defined by vertices of the corresponding polygon in a three-dimensional (3D) space and information of how the vertices are connected, which may be referred to as connectivity information. In some aspects, vertex attributes, such as colors, normals, displacements, and the like, may be associated with the vertices (also referred to as the mesh vertices). Attributes (also referred to as vertex attributes) may also be associated with the surface of the mesh by exploiting mapping information that parameterizes the mesh with two-dimensional (2D) attribute maps. Such mapping may be described by a set of parametric coordinates, referred to as UV coordinates or texture coordinates, associated with the mesh vertices. 2D attribute maps may be used to store high resolution attribute information such as texture, normals, displacements, and the like. The high resolution attribute information may be used for various purposes such as texture mapping, shading, and mesh reconstruction.

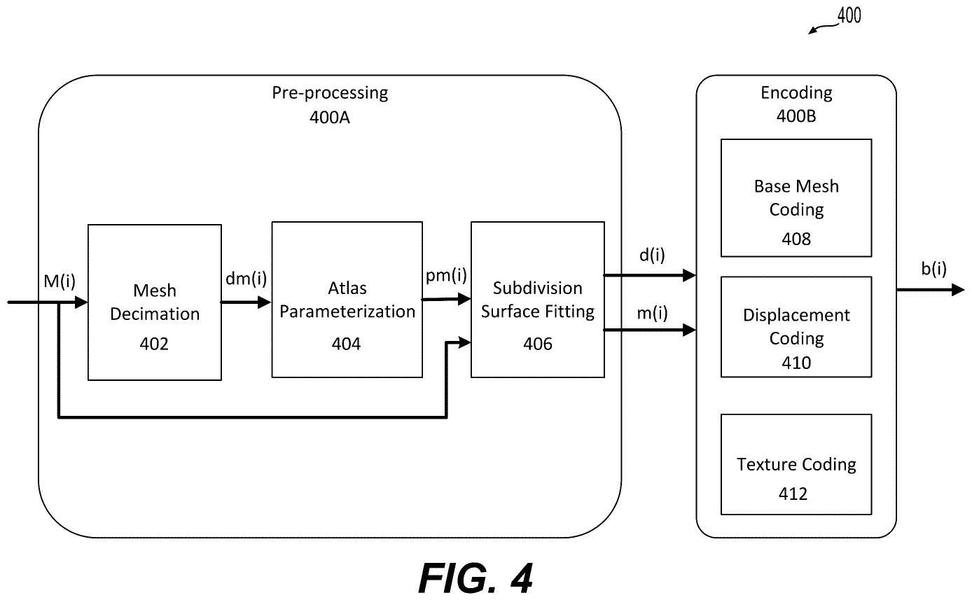

FIG. 4 shows an example of an encoding process (400) for mesh processing based on a related video codec according to an aspect of the disclosure. As shown in FIG. 4, the encoding process (400) may include a pre-processing step (400A) and an encoding step (400B). The pre-processing step (400A) may be configured to generate a base mesh m(i) of a current frame and a displacement field d(i) of the current frame that includes displacement vectors according to an input mesh M(i) of the current frame. The encoding step (400B) may be configured to encode the base mesh m(i), the displacement field d(i), and texture information of the base mesh m(i). The displacement field d(i) of the current frame may include displacement vectors. An index i may refer to the current frame. In an aspect, a mode decision method may be performed in the encoding process (400) to determine whether inter coding (also referred to as inter frame prediction or an inter mode), intra coding (also referred to as intra frame prediction or an intra mode), or the like is applied to the current frame. For example, the mode decision method may compare a cost of an intra mode and a cost of an inter mode and decide a coding mode of the base mesh m(i) of the current frame based on which one of the costs is smaller. In some examples, a skip mode is used to code (e.g., encode or decode) the base mesh m(i). In an example, the skip mode is a special mode of the inter mode. For example, the base mesh m(i) may be intra coded, or inter coded, or coded with the SKIP mode.

Still referring to FIG. 4, the pre-processing step (400A) may include a mesh decimation process (402), a parameterization process such as an atlas parameterization process (404), and a subdivision surface fitting process (406). The mesh decimation process (402) is configured to down-sample vertices of the input mesh M(i) to generate a decimated mesh dm(i) that may include a plurality of decimated (or down-sampled) vertices. A number of the plurality of decimated vertices is less than a number of the vertices of the input mesh M(i). The parameterization process such as the atlas parameterization process (404) is configured to map the decimated mesh dm(i) onto a planar domain, such as onto a UV atlas (or a UV map), to generate a re-parameterized mesh pm(i). In an example, the atlas parameterization may be performed based on a video processing tool, such as a UV Atlas tool. The subdivision surface fitting process (406) is configured to take the re-parameterized mesh pm(i) and the input mesh M(i) as inputs and produce a based mesh m(i) together with the displacement field d(i) that includes the displacement vectors or a set of displacements. In an example of the subdivision surface fitting process (406), pm(i) is subdivided by using a subdivision scheme such as an iterative interpolation to obtain a subdivided mesh. The iterative interpolation includes inserting at each iteration a new point in a middle of each edge of the re-parameterized mesh pm(i). Any suitable subdivision scheme may be applied to subdivide pm(i). The displacement field d(i) is computed by determining a nearest point on a surface of the input mesh M(i) for each vertex of the subdivided mesh.

An advantage of the subdivided mesh may include that the subdivided mesh has a subdivision structure that allows efficient compression, while offering a faithful approximation of the input mesh. The compression efficiency may be obtained due to the following properties. The decimated mesh dm(i) may have a low number of vertices and may be encoded and transmitted using a lower number of bits than the input mesh M(i) or the subdivided mesh. Referring to FIG. 4, the base mesh m(i) may be generated from the decimated mesh dm(i). In an example, the base mesh m(i) is the decimated mesh dm(i). As the subdivided mesh may be generated based on the subdivision method, the subdivided mesh may be automatically generated by the decoder when the base mesh or the decimated mesh is decoded (e.g., there is no need to use any information other than the subdivision scheme and a subdivision iteration count). At the decoder side, the displacement field d(i) may be generated by decoding the displacement vectors associated with the vertices of the subdivided mesh. Besides allowing for spatial/quality scalability, the subdivision structure enables efficient transforms, such as wavelet decomposition, which can offer high compression performance.

The encoding step (400B) may include a base mesh coding (408), a displacement coding (410), a texture coding (412), and the like. The base mesh coding (408) is configured to encode geometric information of the base mesh m(i) associated with the current frame. In an intra encoding, the base mesh m(i) may be first quantized (e.g., using uniform quantization) and then encoded, for example, by the coding mode determined using the mode decision method. The coding mode may be the inter mode, the intra mode, the skip mode, or the like. The encoder used to intra code the base mesh m(i) may be referred to as a static mesh encoder. In the inter encoding, a reference base mesh (e.g., a reconstructed quantized reference base mesh m′(j)) associated with a reference frame indicated by an index j may be used to predict the base mesh m(i) associated with the current frame indicated by the index i. The displacement coding (410) is configured to encode the displacement field d(i) that is generated in the pre-processing step (400A). The displacement field d(i) may include a set of displacement vectors (or displacements) associated with the subdivided mesh vertices. The texture coding (412) is configured to encode attribute information of the base mesh m(i). The attribute information may include texture, normal, color, and/or the like. The attribute information may be encoded based on a suitable codec, such as High-Efficiency Video Coding (HEVC) or Versatile Video Coding (VVC).

In an aspect, referring to FIG. 4, a mesh encoding process such as the encoding process (400) starts with a pre-processing (e.g., the pre-processing step (400A)). The pre-processing may convert the input mesh M(i) into the base mesh m(i) together with the displacement field d(i) including a set of displacements (or a set of displacement vectors). The encoding step (400B) may compress outputs (e.g., m(i), d(i), and the like) from the pre-processing and generate a compressed bitstream b (i). The compressed bitstream b (i) may include a compressed base mesh bitstream, a compressed displacement field bitstream (also referred to as a compressed displacement bitstream), a compressed attribute bitstream, and/or the like.

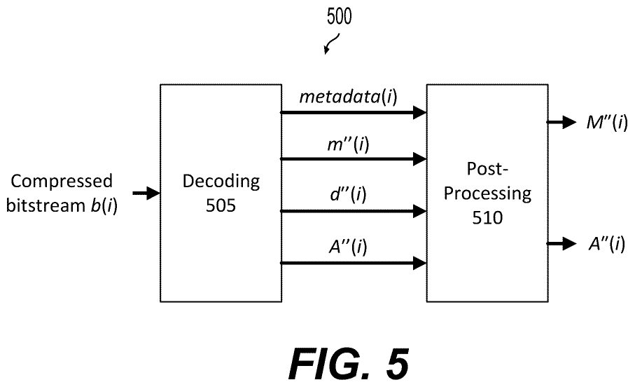

FIG. 5 shows an example of a decoding process (500) for mesh processing according to an aspect of the disclosure. The decoding process (500) may include a decoding step (505) and a post-processing step (510). A compressed bitstream b (i) may be fed to the decoding step (505). In an example, for a lossless transmission, the compressed bitstream b (i) is the output b (i) from the encoding process (400). The decoding step (505) may extract various sub-bitstreams such as the compressed base mesh sub-stream, the compressed displacement field sub-stream, the compressed attribute sub-stream, and/or the like. The decoding step (505) may decompress the sub-bitstreams to generate the following components: patch metadata indicated by metadata (i), a decoded base mesh m″(i), a decoded displacement field (including displacements) d″(i), a decoded attribute map A″(i), and/or the like.

In an aspect, the base mesh sub-stream may be fed to a mesh decoder to generate a reconstructed quantized base mesh m′(i). The decoded base mesh m″(i) may be obtained by applying an inverse quantization to m′(i). The displacement field sub-stream including packed and quantized wavelet coefficients that are encoded may be decoded by a video and/or image decoder. Image unpacking and inverse quantization may be applied to the packed quantized wavelet coefficients that are reconstructed to obtain the unpacked and dequantized transformed coefficients (e.g., wavelet coefficients). An inverse wavelet transform may be applied to the unpacked and dequantized wavelet coefficients to generate the decoded displacement field d″(i).

The decoded components (e.g., including metadata (i), m″(i), d″(i), A″(i), and/or the like) may be fed to a post-processing step (510). A mesh (also referred to as a decoded mesh) M″(i) may be generated by the post-processing step (510) based on m″(i) and d″(i). In an example, the reconstructed deformed mesh DM(i) may be obtained by subdividing m″(i) using a subdivision scheme and applying the reconstructed displacements d″(i) to vertices of a subdivided mesh. In an example, when the encoding process (400), the decoding process (500), and the transmission are lossless, the mesh M″(i) may be the same as the input mesh M(i). When one of the encoding process (400), the decoding process (500), and the transmission is lossy, M″(i) is different from M(i). In various examples, the difference, if any, between M″(i) and M(i) is relatively small. In an example, an attribute map A″(i) is also generated by the post-processing step (510).

A mesh such as a polygon mesh (also interchangeably referred to as a polygonal mesh) may include topologic quantities, such as vertices, edges, and faces, and geometric quantities, such as attributes including vertex positions, face colors, and the like. Connectivity information of a polygon mesh may describe incidences between elements and may be implied by the topology. For example, two vertices are adjacent when an edge is incident to the two vertices. For example, two faces are adjacent when an edge is incident to the two faces.

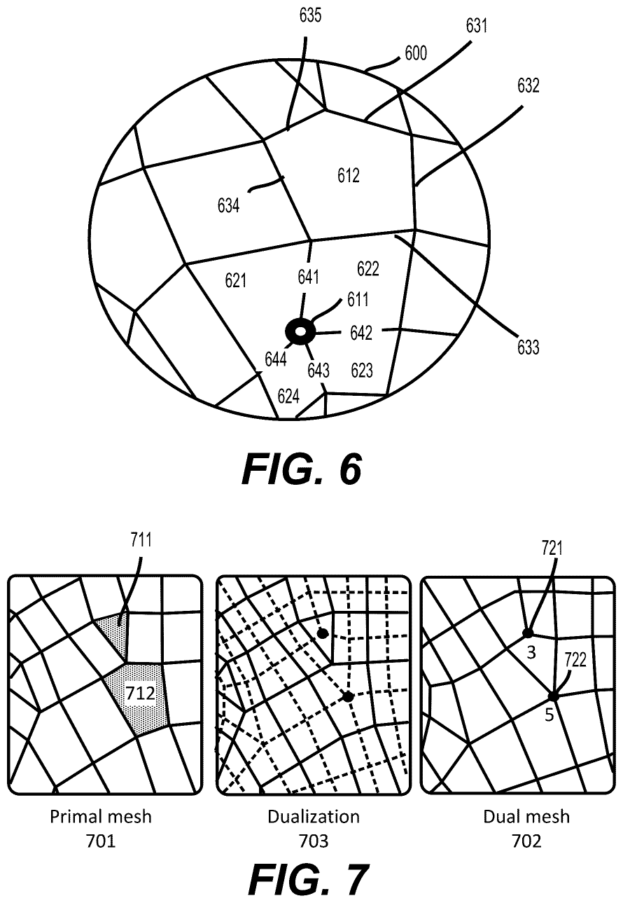

FIG. 6 shows an example of a vertex degree of a vertex (611) and a face degree of a face (612) of a polygon mesh (600) according to an aspect of the disclosure. The polygon mesh (600) may include a plurality of faces that includes the face (612). The polygon mesh (600) may include a plurality of vertices that includes the vertex (611). In an aspect, a vertex degree of a vertex may be interchangeably referred to as a valence of the vertex. A vertex degree of a vertex may specify a number of edges incident to the vertex. Referring to FIG. 6, the vertex degree of the vertex (611) may specify a number of edges (641)-(644) incident to the vertex (611), and the vertex degree of the vertex (611) is 4. A face degree of a face may specify a number of incident edges of the face. Referring to FIG. 6, the face degree of the face (612) may specify a number of incident edges (631)-(635) of the face (612), and the face degree of the face (612) is 5.

In some embodiments, a mesh can include information such as geometry information, connectivity information, mapping information, attributes, and the like. In an aspect, attributes may include vertex attributes and attribute maps. In some examples, the geometry information is described by a set of 3D positions associated with the vertices of the mesh. In an example, (x,y,z) coordinates can be used to describe the 3D positions of the vertices, and are also referred to as 3D coordinates. Referring to FIG. 6, an example of the vertices is the vertex (611). In some examples, the connectivity information includes a set of vertex indices that describes how to connect the vertices to create a 3D surface. In some examples, the mapping information describes how to map the mesh surface to 2D regions of the plane. In an example, the mapping information is described by a set of UV parametric/texture coordinates (u,v) associated with the mesh vertices together with the connectivity information. In some examples, the vertex attributes include scalar or vector attribute values associated with the mesh vertices. In some examples, attribute maps include attributes that are associated with the mesh surface and are stored as 2D images/videos. In an example, the mapping between the videos (e.g., 2D images/videos) and the mesh surface is defined by the mapping information.

In an aspect, UV mapping or mesh parameterization may be used to map faces of a mesh in the 3D domain to the 2D domain. In some examples, a mesh is cut into patches (also referred to as patch components) in the 3D domain. A patch is a contiguous subset of the mesh with a boundary formed of boundary edges. A boundary edge of a patch is an edge that belongs to only one polygon of the patch, and is not shared by two adjacent polygons in the patch. Vertices of boundary edges in a patch are referred to as boundary vertices of the patch, and non-boundary vertices in a patch can be referred to as interior vertices of the patch in some examples.

In an aspect, the patches are parameterized respectively into 2D shapes (also referred to as UV patches, 2D patches, or UV charts) in some examples. The 2D shapes can be packed (e.g., oriented and placed) into a map that is also referred to as a UV atlas in some examples. In some examples, the map can be further processed using 2D image or video processing techniques.

In an example, a UV mapping technique generates a UV atlas (also referred to as UV map) and one or more texture atlas (also referred to as texture map) in 2D corresponding to patches of a 3D mesh. The UV atlas includes assignments of 3D vertices of the 3D mesh to 2D points in a 2D domain (e.g., a rectangular). The UV atlas is a mapping between coordinates of the 3D surface to coordinates of 2D domain. In an example, a point in the UV atlas at a 2D coordinates (u,v) has a value that is formed by coordinates (x, y, z) of a vertex in the 3D domain. In an example, a texture atlas includes color information of the 3D mesh. For example, a point in the texture atlas at the 2D coordinates (u,v) (which has a 3D value of (x,y,z) in the UV atlas) has a color that specifies the color attribute of a point at (x, y, z) in the 3D domain. In some examples, the coordinates (x, y, z) in the 3D domain are referred to as 3D coordinates, or xyz coordinates, and the 2D coordinates (u,v) are referred to as uv coordinates or UV coordinates. In an example, a position of a vertex (e.g., the vertex (611)) in a mesh such as the polygon mesh (600) is indicated by the 3D coordinate (x, y, z), the vertex may correspond to a 2D point in a 2D map or the UV map (e.g., the vertex may be mapped to the 2D point in the UV map), and a position of the 2D point may be indicated by the UV coordinate (u, v).

Mesh compression may include connectivity and/or topology coding and attribute value coding (e.g., value coding for each attribute).

Various methods may be used to code (e.g., encode and/or decode) connectivity of a mesh (e.g., a polygon mesh). In some examples, a dual-degree based method (also referred to as a dual degree coding strategy, a dual degree traversal mode, or the like) and a polygon-fan based method (also referred to as a polygon fan coding strategy, a polygon fan traversal mode, or the like) may be used to code connectivity of a polygon mesh, for example, by traversing the polygon mesh and coding the connectivity around each pivot vertex during the traversal.

In an aspect, the dual-degree based method may code connectivity of a polygon mesh with arbitrary face degrees or arbitrary vertex degrees. The dual-degree based method may use the duality between a primal mesh and a dual mesh to code the connectivity by generating two sequences of symbols, the vertex degrees and face degrees. FIG. 7 shows an example of a primal mesh (701) and a dual mesh (702) according to an aspect of the disclosure. The dual mesh (702) may be built by a dualization process (703), for example, by placing one node in each original face in the primal mesh (701) and connecting the nodes through each edge incident to two original faces in the primal mesh (701). In an aspect, an original face in the primal mesh (701) having a face degree of N1 corresponds to a vertex in the dual mesh (702) having a vertex degree of N1 where the vertex is the node inside the original face. Referring to FIG. 7, an original face (711) in the primal mesh (701) having a face degree of 3 corresponds to a vertex (721) in the dual mesh (702) having a vertex degree of 3. Referring to FIG. 7, an original face (712) in the primal mesh (701) having a face degree of 5 corresponds to a vertex (722) in the dual mesh (702) having a vertex degree of 5.

The dual-degree based method may encode the two sequences of symbols separately. In an example, the dual-degree based method uses a sequence of vertex degrees and a sequence of face degrees. In some examples, coding performance of the dual-degree based method depends highly on a mesh regularity. A mesh regularity may indicate (e.g., measure) a variance of the vertex degrees of the polygon mesh and/or a variance of face degrees of the polygon mesh. In an aspect, the less of the variance of the vertex degrees, the more regular the polygon mesh, and the higher the connectivity coding efficiency. In an aspect, the less of the variance of the face degrees, the more regular the polygon mesh, and the higher the connectivity coding efficiency. In some related technologies, the dual-degree based method is near-optimal for worst-case meshes, where the entropy of the two sequences of symbols may achieve Tutte entropy bound for planar graphs of 2 bits per edge.

In an aspect, vertex and face data structures may be maintained explicitly. For a vertex, a vertex degree (VD) and references to all incident faces in an order (e.g., a counterclockwise order) may be stored in a data structure associated with the vertex. For a face, a face degree (FD) and references to all incident vertices in an order (e.g., a counterclockwise order) may be stored. Vertices and faces may go through a sequence of states such as an empty state, an active state, and a complete state. In an example, at a given time at most one face is active, and multiple vertices may be active. In an example, the multiple active vertices may be held in an active vertex queue. When a face is processed, for example, moved from an empty state (e.g., when the face is not processed), to an active state (e.g., when the face is being processed), and then to a complete state (e.g., when the face is processed), all vertices of the face that are not yet active may be activated through insertion into the active vertex queue. Consequently, each active vertex has at least one complete incident face. When none of faces incident to a vertex is processed, the vertex is not an active vertex and is in an empty state. The vertex is not visited. When all the faces incident to a vertex have become complete (e.g., all the faces are processed), the vertex changes its state to complete (e.g., the vertex is processed) and may be removed from the active vertex queue.

In some examples, the active vertex queue is an active vertex priority queue where an active index having the highest priority is traversed prior to other active indices in the active vertex queue. For example, the active index having the highest priority is made the current vertex such as the pivot vertex, and is processed and then removed from the active vertex queue. In an example, the active vertex queue represents a boundary between a part of the polygon mesh which has already been traversed and a part of the polygon mesh as yet to be visited.

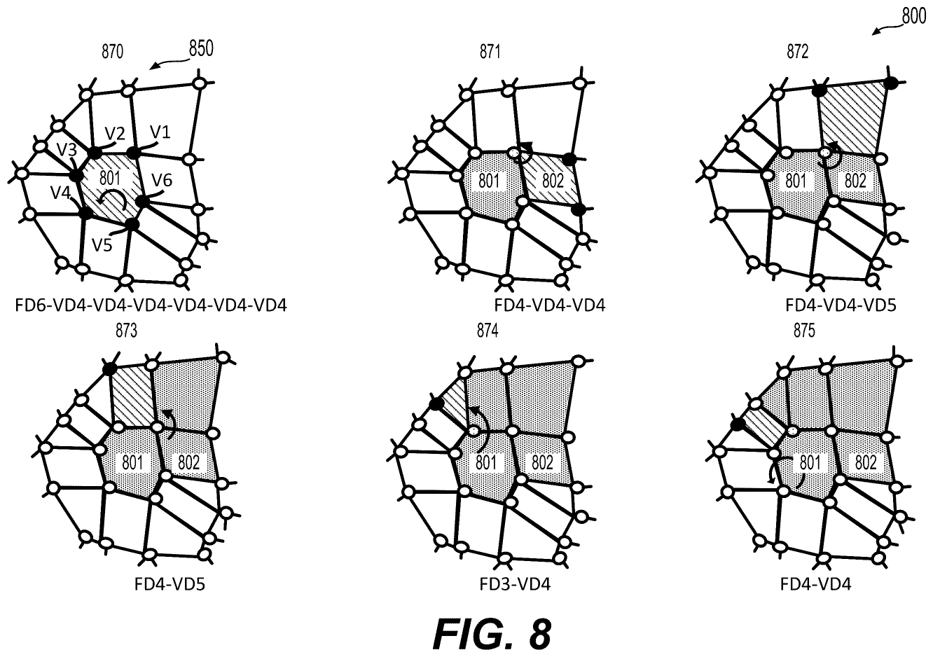

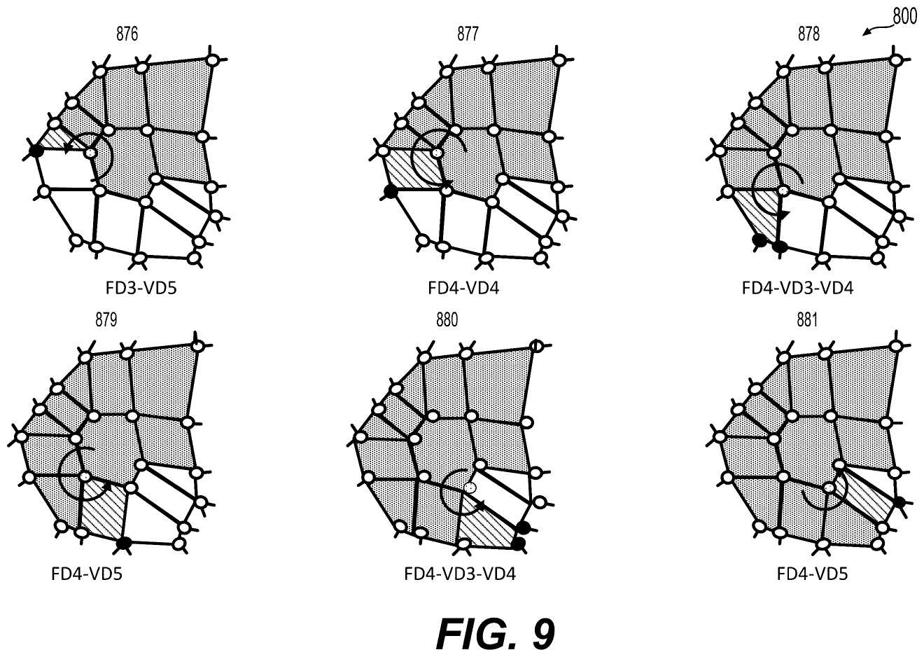

FIGS. 8-9 show an example of a traversal sequence (800) of the dual-degree algorithm according to an aspect of the disclosure. In an example, the traversal sequence (800) may start from a seed face (801) of a polygon mesh (850). At the beginning (e.g., at a step (870)), a seed face degree (FD) (e.g., 6 as indicated by FD6) may be output along with vertex degrees of all vertices of the seed face (801). In the example shown in FIG. 8, the seed face (801) has 6 vertices V1-V6, each of the vertices has a vertex degree (VD) of 4 as indicated by VD4.

At a step (871), a first vertex (e.g., V1) of the seed face (801) may become active and a next face (802) may be traversed, for example, in a counterclockwise order, resulting in one face degree and two vertex valences output, such as FD4, VD4, and VD4.

The traversal keeps going until all the faces and vertices in the polygon mesh (850) have been visited.

In an example, the seed face (801) is chosen and all neighbors of the seed face (801) are traversed recursively until all faces of the corresponding connected component are visited. Referring to FIGS. 8-9, a subset of all neighbors of the seed face (801) is traversed in the steps (872)-(881). A new seed face of the next connected component is then chosen and the traversal sequence (800) may continue. Every time the encoder traverses the next element of the polygon mesh (850), the encoder may output some symbol which uniquely identifies a new state. From this stream of symbols, the decoder can reconstruct the polygon mesh (850). In an example, two sets of symbols may be used to encode vertex degrees and face degrees. At a given moment, the encoder and the decoder may know which type of symbol (face or vertex) is being dealt with.

In an aspect, the mesh traversal such as the traversal sequence (800) may be started by selecting the seed face (801). The encoder outputs the face degree of the seed face (801), followed by the vertex degrees of all the vertices V1-V6 incident to the seed face (801), e.g., in a counterclockwise order such as FD6-VD4-VD4-VD4-VD4-VD4-VD4 in the step (870). The vertices (e.g., the 6 vertices V1-V6) may be added to the active vertex queue. The decoder may receive the seed face degree (e.g., FD6) and creates a corresponding face. The decoder may fill all the slots for the incident vertices, moving the incident vertices from the empty to active state, e.g., enters the incident vertices into an active vertex queue of the decoder. Thus, the encoder and the decoder may maintain matching states.

The traversal such as the traversal sequence (800) may continue by removing the highest priority active vertex from the active vertex queue and making it the current vertex. The algorithm proceeds, for example, counterclockwise around the active vertex, skipping all faces which have already been completed. In an example, for an active vertex, at least one face is completed and at least one incident face is still empty, otherwise the vertex may not be in the active vertex queue.

When the encoder detects an empty face, such as an empty slot in the incident face data structure associated with the current vertex, the encoder may proceed through the following steps: (i) the face is activated and becomes the “current” face, and a face degree of the current face is output; (ii) the current face is added to an appropriate slot in the incident face data structures associated with the current vertex as well as any other active vertices which are incident to current face; (iii) any remaining empty vertices of the current face are activated and the respective vertex degrees output in an order, for example, in a counterclockwise order; and (iv) the current face is complete and removed from processing.

In an aspect, referring to FIGS. 8-9, the active vertex and the subsequently selected active face may be considered as successive pivots, and may be referred to as a pivot vertex and a current face, respectively.

The decoder may use a symmetric procedure, ensuring the same traversal as the encoder. When the decoder finds the first empty face slot in the currently active vertex, the decoder may proceed as follows: (i) read in a face degree and create the face, moving the face from state “empty” to “active,” calling the face the “current” face; (ii) add the current face to the appropriate slot in the active vertex and any other active vertices the current face is incident on; (iii) read the vertex degrees of the remaining empty vertices incident on the current face, activating the remaining empty vertices incident on the current face through insertion into the active vertex queue; (iv) move the current face to the complete state.

In an example, vertices completed during the traversal of the current face are removed from the active vertex queue. The vertices completed during the traversal of the current face no further belong to the boundary of the traversed region. After the current face is processed, the algorithm proceeds to the next face in the currently active vertex until the currently active vertex is complete. Subsequently a new active vertex is taken from the queue and the process repeats until the active vertex queue is empty. If there are some connected components remaining, a new seed face is chosen on it and another component traversal starts.

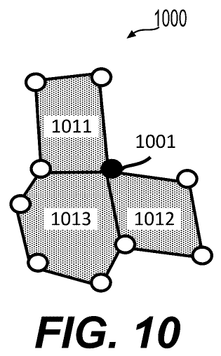

In an aspect, vertices of a polygon mesh may be traversed by an encoder, for example, according to a deterministic order reproducible at a decoder side. In an example, in each step, faces incident to a current vertex may be decomposed into a set of polygon-fans sharing the current vertex as a pivot, such as shown in FIG. 10. FIG. 10 shows an example of a polygon-fan (1000) according to an aspect of the disclosure. The polygon-fan (1000) includes three incident faces (1011)-(1013) that share a pivot (or a pivot vertex) (1001). In an aspect, all faces in a polygon-fan are incident to a pivot vertex, and the polygon-fan includes consecutive faces. Two of the consecutive faces may share an edge.

In an example, connectivity and geometry of polygon-fans are coded (e.g., encoded and/or decoded) in an interleaved manner. For each polygon-fan, connectivity information of the respective polygon-fan is coded.

Various vertex traversal methods may be used. The vertex traversal methods may include valence-based traversal, geometry-based traversal, and the like. The valence-based traversal and the geometry-based traversal may keep track of a list of active vertices, which correspond to vertices to be visited and compressed next. The vertices in the list may be stored in a priority queue such as an active vertex priority queue described in the disclosure and visited according to the priority (e.g., vertices with the highest priority are visited first). The valence-based traversal and the geometry-based traversal may define two different priority measures. In an example, the valence-based traversal exploits the connectivity information and measures the priority of an active vertex by counting a number of already encoded polygons (e.g., triangles) incident to the active vertex. The geometry-based traversal may exploit both the connectivity and geometry information. The geometry-based traversal may measure the priority of an active vertex by computing conquered valence, for example, defined as a sum of angles (e.g., diamond angles) of already encoded polygons (e.g., triangles) incident to it.

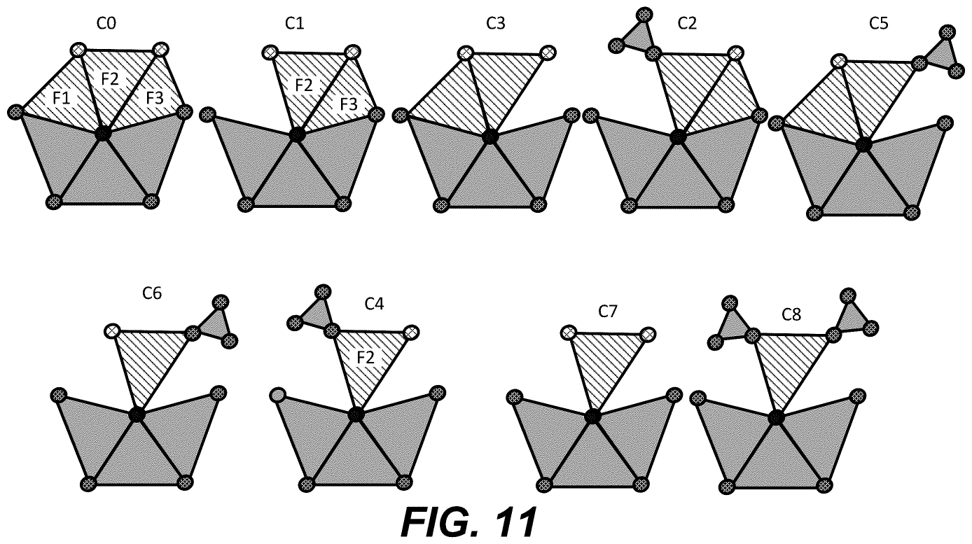

In some examples, a polygon-fan is triangulated and a number of triangles for each face may be compressed by using the context adaptive binary arithmetic. In an example, the connectivity of the obtained triangle-fans is compressed by using nine topological configurations C0-C8 shown in FIG. 11. FIG. 11 shows an example of topological configurations C0-C8 used to compress a triangle-fan connectivity according to an aspect of the disclosure. Referring to FIG. 11, a polygon-fan of each topological configuration includes hatched face(s). For example, the polygon-fan of C0 includes 3 hatched face(s) F1-F3, the polygon-fan of C1 includes 2 hatched face(s) F2-F3, and the polygon-fan of C4 includes 1 hatched face.

In an aspect, the polygon-fan method may be used to code (e.g., encode and/or decode) connectivity of a polygon mesh. To code the connectivity at a pivot vertex, the polygon-fan method may determine polygon-fans. For each polygon-fan, a number of faces and a face degree of each face may be coded using an entropy coding method. In some examples, a polygon-fan may be triangulated, resulting in a triangle-fan, whose connectivity is coded (e.g., encoded and/or decoded) using a plurality of topological configurations shown in FIG. 11.

In some examples, the attributes include one or more of positions, texture coordinates, normal, and the like. A predictive coding scheme is used to code (e.g., encode and/or decode) the attribute values where a residue between an original attribute value and a predicted attribute value is entropy coded. In an aspect, a set of candidate predictors may be available, and a predictor index (e.g., an optimal predictor index) may be signaled alongside.

High-level syntax for coding geometry in polygon mesh compression is described. In some examples, a mesh (e.g., a polygon mesh) includes a plurality of connected components (CCs). In an example, an edge connects two adjacent vertices. In an example, a path includes a set of consecutive edges. In a connected component, a first vertex in the connected component may be connected to a second vertex in the connected component by a path. In an example, other vertices in the connected component are reached by the first vertex via respective paths. Faces in the connected component may be reached by traversal from the first vertex. In an example, any two vertices in the connected component are connected by a respective path.

In some examples, the plurality of connected components has different characteristics, and thus it is beneficial to divide the plurality of connected components into different groups of connected components such that the groups of connected components may be coded adaptively and efficiently. In some examples of the disclosure, each group of connected components is a slice (e.g., a geometry slice) in the mesh, and different groups of connected components are difference slices.

A connected component may have one or more characteristics, such as one or more topological characteristics. The one or more characteristics, such as the one or more topological characteristics, may be determined based on information of the connected component. In some examples, the one or more characteristics include one or more of (i) orientability of the connected component, (ii) whether the connected component is 2-manifold, (iii) whether the connected component has a degenerate face, (iv) a face degree mode of the connected component, and (v) a vertex degree mode of the connected component.

In an example, a face that includes a repeated incident index is a degenerate face. For example, a face (e.g., a triangular face) including vertices 1-3 is not degenerate. A face including vertices 1, 2, and 2 is a degenerate face.

A face degree mode of the connected component refers to a most frequent face degree (or a dominant face degree) of the connected component. For example, a face degree mode of 4 indicates that the most frequent face degree of the connected component is 4.

A vertex degree mode of the connected component refers to a most frequent vertex degree (or a dominant vertex degree) of the connected component. For example, a vertex degree mode of 4 indicates that the most frequent vertex degree of the connected component is 4.

In an aspect, the connected component is orientable if all faces in the connected component have compatible orientations. Otherwise the connected component is called non-orientable. In some examples, the orientability is determined by checking if there are duplicated half-edges in the connected component.

For a face in the connected component, the orientation of the face is a cyclic order of its vertices. For example, if a face includes vertices v₁, v₂ and v₃, then the orientation of {2,3,1} is the same as the one of {1,2,3}, which is different from the orientation of {1,3,2}. The orientations of two adjacent faces are compatible if they have opposite directions on the common edges, such as edges shared by the two adjacent faces.

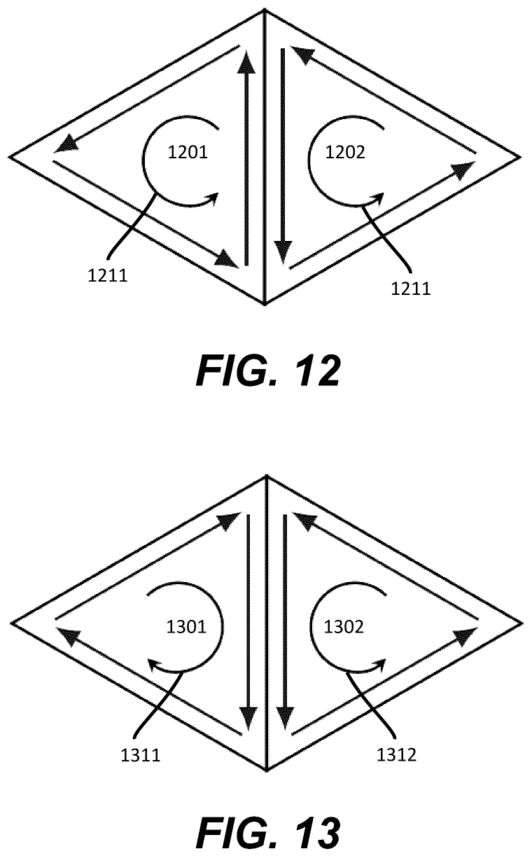

FIG. 12 shows an example of compatible orientations according to an aspect of the disclosure. FIG. 13 shows an example of incompatible orientations according to an aspect of the disclosure. For example, orientations of faces (1201)-(1202) in FIG. 12 are both in a counter-clockwise direction (1211) and are compatible. Referring to FIG. 13, a face (1301) and a face (1302) are in a clockwise direction (1311) and a counter-clockwise direction (1312), respectively, and are incompatible.

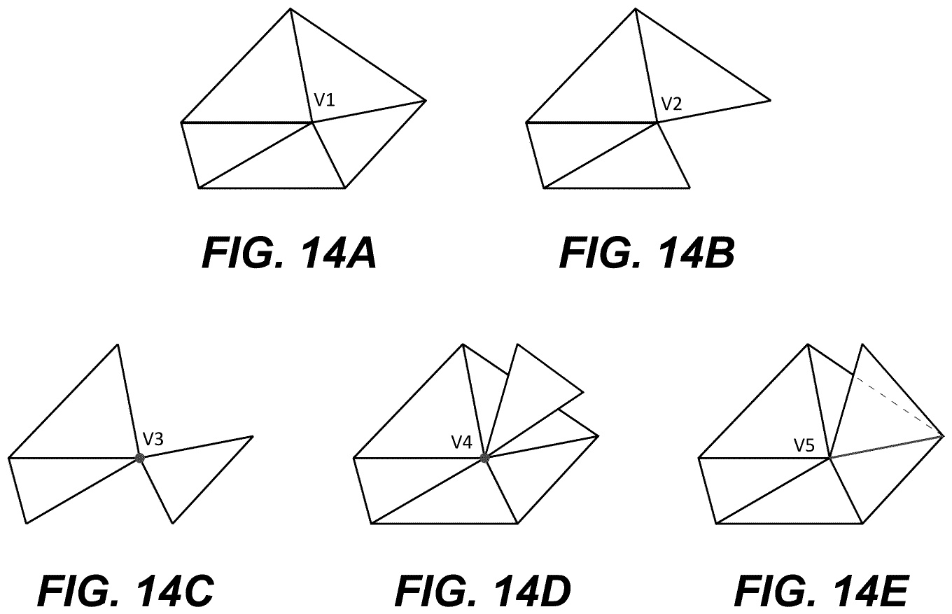

In an aspect, the connected component is a 2-manifold if every point on the connected component has a neighborhood homeomorphic to an open disk or a half disk. In an aspect, the connected component is a 2-manifold if there is a unique face-fan (closed or open) around each vertex in the connected component. In some examples, the manifoldness is determined by checking if there is a unique face-fan around each vertex in the connected component. FIG. 14A shows an example of a closed face-fan around a vertex V1 in a manifold according to an aspect of the disclosure. FIG. 14B shows an example of an open face-fan around a vertex V2 in a manifold according to an aspect of the disclosure. FIG. 14C shows an example of more than one face-fan around a vertex V3 in a non-manifold according to an aspect of the disclosure. FIG. 14D shows an example of more than one face-fan around a vertex V4 in a non-manifold according to an aspect of the disclosure. FIG. 14E shows an example of more than one face-fan around a vertex V5 in a non-manifold according to an aspect of the disclosure.

As described in the disclosure, different connected components may have different characteristics. In some examples, it is not efficient to code (e.g., code geometry) the different connected components together as a whole.

According to an aspect of the disclosure, the different connected components may be divided into slices (e.g., groups of connected components) in the mesh based on the characteristics, and thus improving the coding efficiency. High-level (e.g., a mesh level, a slice level, and/or the like) syntaxes may be used for a mesh and slices. In an example, a slice refers to a group of connected components.

In syntax Tables 1 and 2 below, the prefix “gmh” stands for “geometry mesh header”, the prefix “gsh” stands for “geometry slice header”, the prefix “sps” stands for “sequence parameter set”, and the prefix “gps” stands for “geometry parameter set”.

Table 1 shows an example of syntax in a geometry mesh header. The syntax may be applied to coding the geometry of a polygon mesh.

TABLE 1
Syntax in a geometry mesh header

| | Descriptor |
|---|---|
| geometry_mesh_header ( ) { | |
| gmh_seq_parameter_set_id | u(4) |
| gmh_geo_parameter_set_id | u(4) |
| gmh_frame_order_hint | u(n) |
| gmh_mesh_id | ue(v) |
| gmh_origin_bits | ue(v) |
| if (gmh_origin_bits > 0) { | |
| for (i = 0; i < 3; ++i) | |
| gmh_origin[i] | s(n) |
| if (gps_origin_scale_present_flag) { | |
| gmh_origin_log2_scale | ue(v) |
| } | |
| } | |
| for (i = 0; i < 3; ++i) | |
| gmh_component_bit_depth[i] | ue(v) |
| gmh_num_primitive_bits_minus1 | ue(v) |
| gmh_num_vertices_minus1 | u(n) |
| gmh_num_faces | u(n) |
| gmh_num_indices_delta | se(v) |
| gmh_face_type | u(2) |
| gmh_prediction_strategy | u(4) |
| gmh_singleway_prediction_mode | u(4) |
| gmh_multiway_prediction_mode | u(4) |
| gmh_singleway_prediction_log2_update_period | u(4) |
| gmh_multiway_prediction_log2_update_period | u(4) |
| gmh_group_context_mode | u(1) |
| gmh_flip_sign_mode | u(1) |
| gmh_regularize_connectivity | u(1) |
| if (sps.sps_geometry_description.gd_symmetry_enabled) | |
| { | |
| gmh_symmetry_present | u(1) |
| if (gmh_symmetry_present) { | |
| gmh_symmetry_plane_idx | u(2) |
| if (gmh_symmetry_plane_idx < 3) { | |
| gmh_symmetry_plane_d | u(32) |
| } else { | |
| for (i = 0; i < 4; ++i) { | |
| gmh_symmetry_plane_nonparallel[i] | s(32) |
| } | |
| } | |
| } | |
| } | |
| byte_align( ) | |
| } | |

Referring to Table 1, gmh_seq_parameter_set_id indicates a sequence parameter set identifier, gmh_geo_parameter_set_id indicates a geometry parameter set identifier, gmh_frame_order_hint indicates frame order hint, and gmh_mesh_id indicates an identifier of the mesh.

Referring to Table 1, gmh_origin indicates a geometry origin, and gmh_origin_bits indicates a length in bits of the gmph_origin.

Referring to Table 1, gmh_component_bit_depth indicates a geometry components bit depth.

Referring to Table 1, gmh_num_primitive_bits_minus1 indicates a length in bits of gmh_num_vertices_minus1 and gmh_num_faces, gmh_num_vertices_minus1 indicates a number of vertices in the mesh, gmh_num_faces indicates a number of faces in the mesh, gmh_num_indices_delta indicates a number of indices delta in the mesh, gmh_face_type indicates a mesh face type (or a face type of the mesh), gmh_prediction_strategy indicates a geometry prediction strategy (e.g., for predicting positions of vertices) for the mesh, gmh_singleway_prediction_mode indicates a singleway prediction mode, for example, using a parallelogram, gmh_multiway_prediction_mode indicates a multiway prediction mode, for example, using multiple parallelograms, gmh_singleway_prediction_log 2_update_period indicates a geometry singleway prediction update period, gmh_multiway_prediction_log 2_update_period indicates a geometry multiway prediction update period, gmh_group_context_mode (e.g., a flag) indicates whether group context coding is used or not, and gmh_flip_sign_mode (e.g., a flag) indicates whether a flip sign bit is encoded or a sign bit.

Referring to Table 1, gmh_symmetry_present indicates whether a symmetry plane is present for the mesh, gmh_symmetry_plane_idx indicates a symmetry plane index, gmh_symmetry_plane_d indicates a symmetry plane equation d, and gmh_symmetry_plane_nonparallel indicates symmetry plane information.

Table 2 shows an example of syntax in a geometry slice header. The syntax may be applied to coding the geometry (e.g., including coding connectivity) of a slice in the mesh. As described in the disclosure, in some examples, a slice is a group of connected components in the mesh. Syntax elements in the geometry slice header are high-level syntax elements corresponding to a slice level or a group of connected components in the mesh.

TABLE 2
Syntax in a geometry slice header

| | Descriptor |
|---|---|
| geometry_slice_header( ) { | |
| gsh_mesh_id | ue(v) |
| gsh_num_primitive_present_flag | u(1) |
| if (gsh_num_primitive_present_flag) { | |
| gsh_num_vertices_minus1 | u(n) |
| gsh_num_faces | u(n) |
| gsh_num_indices_delta | se(v) |
| if (gmh_face_type > 1) { | |
| gsh_face_type | u(2) |
| } | |
| gsh_prediction_info_present_flag | u(1) |
| if (gsh_prediction_info_present_flag) { | |
| gsh_prediction_strategy | u(4) |
| gsh_singleway_prediction_mode | u(4) |
| gsh_multiway_prediction_mode | u(4) |
| gsh_singleway_prediction_log2_update_period | u(4) |
| gsh_multiway_prediction_log2_update_period | u(4) |
| } | |
| gsh_binarization_info_present_flag | u(1) |
| if (gsh_binarization_info_present_flag) { | |
| gsh_group_context_mode | u(1) |
| gsh_flip_sign_mode | u(1) |
| } | |
| } | |
| gsh_regularize_connectivity | u(1) |
| if (gsh_regularize_connectivity == false) { | |
| gsh_repeated_connected_components_mode | u(1) |
| if (gsh_repeated_connected_components_mode) { | |
| gsh_num_connected_components | ue(v) |
| gsh_prediction_refinement_log2_update_count | u(4) |
| gsh_prediction_refinement_log2_threshold | u(4) |
| } | |
| } | |
| gsh_indices_coding_strategy | u(1) |
| if (gsh_indices_coding_strategy == 0) { | |
| gsh_polygonfan_traversal_strategy | u(2) |
| if (gsh_face_type > 0) { | |
| gsh_quad_dominated | u(1) |
| } | |
| } else { | |
| gsh_dualdegree_traversal_strategy | u(2) |
| gsh_vertex_degree_mode_residual | se(v) |
| gsh_has_dummy_faces | u(1) |
| } | |
| byte_align( ) | |
| } | |

Referring to Table 2, gsh_mesh_id indicates a mesh identifier of the mesh to which the slice belongs, gsh num_vertices_minus1 indicates a number of vertices in the slice, gsh_num_faces indicates a number of faces in the slice, gsh_num_indices_delta indicates a number of indices in the slice, and gsh_num_primitive_present_flag (e.g., a flag) indicates whether the number of vertices in the slice, the number of faces in the slice, and the number of indices in the slice are signaled in the geometry slice header.

In some examples, the face type of the mesh (also referred to as the mesh face type indicated by gmh_face_type) is 0 when the mesh is a triangular mesh, and the face type of the mesh indicated by gmh_face_type is 1 when the mesh is a quad mesh. When gmh_face_type is 0 or 1, there is no need to signal a face type of the slice. Referring to Table 2, in an example, when the face type of the mesh indicated by gmh_face_type is larger than 1, gsh_face_type indicating the face type of the slice is signaled in the geometry slice header. When the face type of the mesh indicated by gmh_face_type is not larger than 1, gsh_face_type is not signaled in the geometry slice header.

Referring to Table 2, gsh_prediction_info_present_flag (e.g., a flag) indicates whether prediction information for the slice is signaled. When gsh prediction_info_present_flag indicates that the prediction information for the slice is signaled, a geometry prediction strategy for the slice indicated by gsh_prediction_strategy is signaled. Further, the following syntax elements are signaled for the slice: gsh_singleway_prediction_mode indicating a singleway prediction mode for the slice, for example, using a parallelogram, gsh_multiway_prediction_mode indicating a multiway prediction mode for the slice, for example, using multiple parallelograms, gsh_singleway_prediction_log 2_update_period indicating a geometry singleway prediction update period for the slice, and gsh_multiway_prediction_log 2_update_period indicating a geometry multiway prediction update period for the slice. Otherwise, when gsh_prediction_info_present_flag indicates that the prediction information for the slice is not signaled, the prediction information (e.g., gmh_prediction_strategy, gmh_singleway_prediction_mode, gmh_multiway_prediction_mode, gmh_singleway_prediction_log 2_update_period, and gmh_multiway_prediction_log 2_update_period signaled in the geometry mesh header) in the mesh level may be used for the slice, and the syntax elements gsh_prediction_strategy, gsh_singleway_prediction_mode, gsh_multiway_prediction_mode, gsh_singleway_prediction_log 2_update_period, and gsh_multiway_prediction_log 2_update_period are not signaled in the geometry slice header.

Referring to Table 2, gsh_binarization_info_present_flag (e.g., a flag) indicates whether to signal binarization information in the geometry slice header. When gsh_binarization_info_present_flag indicates that the binarization information is to be signaled in the geometry slice header, syntax elements gsh_group_context_mode and gsh_flip_sign_mode are signaled in the geometry slice header. gsh_group_context_mode (e.g., a flag) indicates whether group context coding is used or not for the slice. gsh_flip_sign_mode (e.g., a flag) indicates whether a flip sign bit is encoded or a sign bit in the geometry slice header.

Referring to Table 2, gsh_repeated_connected_components_mod indicates whether connected components in the slice are repeated, for example, whether the connected components in the slice have the same connectivity. When gsh_repeated_connected_components_mod indicates that the connected components in the slice are repeated, syntax elements gsh_num_connected_components, gsh_prediction_refinement_log 2_update_count, and gsh_prediction_refinement_log 2_threshold are signaled in the geometry slice header. gsh_num_connected_components indicates a number of connected components. gsh_prediction_refinement_log 2_update_count indicates a geometry prediction refinement count. gsh prediction_refinement_log 2_threshold indicates a geometry prediction refinement threshold.

Referring to Table 2, according to an aspect of the disclosure, a geometry indices coding strategy (also referred to as a geometry coding strategy) indicated by a first syntax element gsh_indices_coding_strategy is signaled in the geometry slice header. The geometry indices coding strategy may be one of a plurality of geometry indices coding strategies including, for example, a polygon fan coding strategy, a dual degree coding strategy, and the like.

Referring to Table 2, in an example, the first syntax element gsh_indices_coding_strategy is signaled using a flag, the first syntax element gsh_indices_coding_strategy being “0” indicates that the geometry indices coding strategy is the polygon fan coding strategy, and the first syntax element gsh_indices_coding_strategy being not “0” indicates that the geometry indices coding strategy is the dual degree coding strategy.

Referring to Table 2, in an example, when the first syntax element gsh_indices_coding_strategy being “0” indicates that the geometry indices coding strategy is the polygon fan coding strategy, a second syntax element gsh_polygonfan_traversal_strategy is signaled in the geometry slice header. The second syntax element gsh_polygonfan_traversal_strategy indicates a polygon fan traversal strategy in a plurality of polygon fan traversal strategies. The plurality of polygon fan traversal strategies includes connectivity guided traversal strategy, geometry guided traversal strategy, and the like. In an example, when the geometry coding strategy is the polygon fan coding strategy and a face type of the slice (e.g., the group of connected components) is not a triangular face type (e.g., gsh_face_type>0), a third syntax element gsh_quad_dominated for the slice is signaled in the geometry slice header. The third syntax element gsh_quad_dominated indicates whether the slice is quad dominated. In an example, the slice is quad dominated when a face degree mode of the slice and a vertex degree mode of the slice are both equal to 4.

Referring to Table 2, in an example, when the first syntax element gsh_indices_coding_strategy being not “0” indicates that the geometry indices coding strategy is the dual degree coding strategy, a fourth syntax element gsh_dualdegree_traversal_strategy is signaled in the geometry slice header. The fourth syntax element gsh_dualdegree_traversal_strategy indicates a dual degree traversal strategy in the plurality of polygon fan traversal strategies.

In an example, when the geometry coding strategy is the dual degree coding strategy, a fifth syntax element gsh_vertex_degree_mode_residual for the slice is signaled in the geometry slice header. The fifth syntax element indicates a vertex degree mode (e.g., the dominant vertex degree) of the slice. In an example, the vertex degree mode is not signaled directly. For example, a prediction of the vertex degree mode is performed, and a residual of the vertex degree mode is signaled. The residual of the vertex degree mode is indicated by the fifth syntax element gsh_vertex_degree_mode_residual.

In an example, when the geometry coding strategy is the dual degree coding strategy, a sixth syntax element gsh_has_dummy_faces for the slice is signaled in the geometry slice header. The sixth syntax element indicates whether the slice includes a dummy face. In an example, a dummy face refers to an artificial or placeholder face that is introduced into the slice data structure or during the mesh compression process. In an example, an original slice includes a cube with the top face removed. To code the cube efficiently, a dummy face is added to the top face of the cube such that the cube has 6 faces during coding. After coding, the top face may be removed to recover the original cube.

In an example, when information associated with geometry coding strategies is signaled in the geometry slice header for a slice, the corresponding information is not signaled in the geometry mesh header. Comparing Tables 1 and 2, the syntax elements gsh_indices_coding_strategy, gsh_polygonfan_traversal_strategy, gsh_quad_dominated, gsh_dualdegree_traversal_strategy, gsh_vertex_degree_mode_residual, gsh_has_dummy_faces, and the like are signaled in the geometry slice header for a slice, and corresponding syntax elements (e.g., gmh_indices_coding_strategy, gmh_polygonfan_traversal_strategy, gmh_quad_dominated, gmh_dualdegree_traversal_strategy, gmh_vertex_degree_mode_residual, gmh_has_dummy_faces) are not signaled in the geometry mesh header, and thus Table 1 in the disclosure may be different from another geometry mesh header when the methods described in the disclosure are not used.

According to an aspect of the disclosure, a mesh including a plurality of connected components is divided into a plurality of groups of connected components based on at least one topological characteristic of each connected component. In some examples, each group of connected components is a slice. A first syntax element (e.g., gsh_indices_coding_strategy in Table 2) for a first group of connected components (e.g., a first slice) of the plurality of groups of connected components in a bitstream is decoded. The first syntax element indicates a first geometry coding strategy for coding a geometry of the first group of connected components. The first group of connected components has the same at least one topological characteristic. The geometry of the first group of connected components is decoded with the first geometry coding strategy that is different from a second geometry coding strategy for a geometry of a second group of connected components in the plurality of groups of connected components. In an example, coding the geometry of a group of connected components includes one or more of coding connectivity of the group of connected components, predicting positions of vertices of the group of connected components, and/or the like.

In an example, the at least one topological characteristic of each connected component includes one or more of (i) orientability of the respective connected component, (ii) whether the respective connected component is manifold (e.g., 2-manifold), (iii) whether the respective connected component has a degenerate face, (iv) a face degree mode of the respective connected component, and (v) a vertex degree mode of the respective connected component.

In an example, the at least one topological characteristic of each connected component includes whether the respective connected component is manifold, and the plurality of connected components is grouped based on whether the respective connected component is manifold. Thus, connected components being manifold are grouped into a group A, and connected components being non-manifold are grouped into a group B. Thus, the plurality of connected components is grouped into the group A and the group B. Different geometry coding strategies may be more suitable for a group of connected components with certain topological characteristics. For example, the dual degree coding strategy is more suitable for coding a group of connected components of manifold, and thus is used to code the group A, and the polygon fan coding strategy is more suitable for coding a group of connected components of non-manifold, and thus is used to code the group B.

In an example, the at least one topological characteristic of each connected component includes (i) orientability of the respective connected component, (ii) whether the respective connected component is manifold (e.g., 2-manifold), (iii) whether the respective connected component has a degenerate face, (iv) a face degree mode of the respective connected component, and (v) a vertex degree mode of the respective connected component. If a connected component is an orientable 2-manifold without degenerate faces and its most frequent face degree and vertex degree are both 4, then the connected component is in a group C; otherwise, the connected component is in a group D. In an example, the dual degree coding strategy is used to code the group C, and the polygon fan coding strategy is used to code the group D.

In an example, the first group of connected components is a first slice in the mesh, and the first syntax element is a slice level syntax element. For example, the first syntax element is signaled in a geometry slice header, such as shown in Table 2.

In an example, the first geometry coding strategy is one of the polygon fan coding strategy and the dual degree coding strategy.

In an example, when the first geometry coding strategy is the polygon fan coding strategy, a second syntax element (e.g., gsh_polygonfan_traversal_strategy shown in Table 2) for the first group of connected components is decoded. The second syntax element indicates a polygon fan traversal strategy in a plurality of polygon fan traversal strategies. The plurality of polygon fan traversal strategies includes connectivity guided traversal strategy, geometry guided traversal strategy, and the like.

In an example, when the first geometry coding strategy is the polygon fan coding strategy and a face type of the first group of connected components is not a triangular face type, a third syntax element (e.g., gsh_quad_dominated shown in Table 2) for the first group of connected components is decoded. The third syntax element indicates whether the first group of connected components is quad dominated. The first group of connected components is quad dominated when a face degree mode of the first group of connected components and a vertex degree mode of the first group of connected components are equal to 4.

In an example, when the first geometry coding strategy is the dual degree coding strategy, a fourth syntax element (e.g., gsh_dualdegree_traversal_strategy shown in Table 2) for the first group of connected components is decoded. The fourth syntax element indicates a dual degree traversal strategy in a plurality of dual degree traversal strategies.

In an example, when the first geometry coding strategy is the dual degree coding strategy, a fifth syntax element (e.g., gsh_vertex_degree_mode_residual shown in Table 2) for the first group of connected components is decoded. The fifth syntax element indicates a vertex degree mode of the first group of connected components.

In an example, when the first geometry coding strategy is the dual degree coding strategy, a sixth syntax element (e.g., gsh_has_dummy_faces shown in Table 2) for the first group of connected components is decoded. The sixth syntax element indicates whether the first group of connected components includes a dummy face.

In an example, the second syntax element, the third syntax element, the fourth syntax element, the fifth syntax element, and the sixth syntax element are slice level syntax elements. For example, the second syntax element, the third syntax element, the fourth syntax element, the fifth syntax element, and the sixth syntax element are signaled in the geometry slice header, such as shown in Table 2.

In an example, the first syntax element, the second syntax element, the third syntax element, the fourth syntax element, the fifth syntax element, and the sixth syntax element are high-level syntax elements, such as syntax elements signaled at a level (e.g., a slice level) for a group of connected components having the same topological characteristic(s).

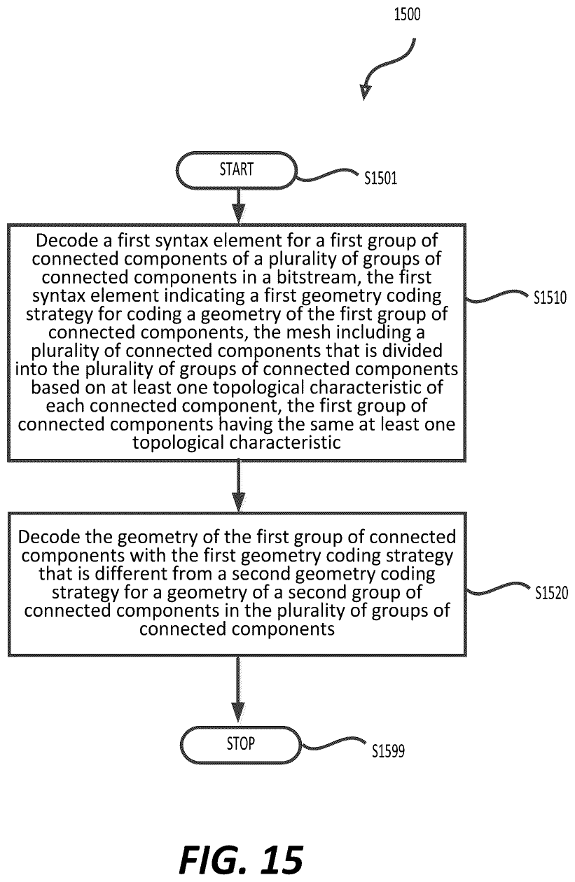

FIG. 15 shows a flow chart outlining a process (1500) according to an aspect of the disclosure. The process (1500) can be used in an apparatus. The apparatus may include a mesh decoder, such as a video decoder. The video decoder is configured to, for example, decode one or more meshes. In various aspects, the process (1500) is executed by processing circuitry, such as the processing circuitry that performs functions of the video decoder (110), the processing circuitry that performs functions of the video decoder (210), the mesh decoder, and/or the like. In some aspects, the process (1500) is implemented in software instructions, thus when the processing circuitry executes the software instructions, the processing circuitry performs the process (1500). The process starts at (S1501) and proceeds to (S1510).

At (S1510), a first syntax element for a first group of connected components of a plurality of groups of connected components in a bitstream is decoded. The first syntax element indicates a first geometry coding strategy for coding a geometry of the first group of connected components. A mesh includes a plurality of connected components that is divided into the plurality of groups of connected components based on at least one topological characteristic of each connected component. The first group of connected components has the same at least one topological characteristic.

In an example, the at least one topological characteristic of each connected component includes one or more of (i) orientability of the respective connected component, (ii) whether the respective connected component is 2-manifold, (iii) whether the respective connected component has a degenerate face, (iv) a face degree mode of the respective connected component, and (v) a vertex degree mode of the respective connected component.

In an example, the first group of connected components is a first slice in the mesh, and the first syntax element is a slice level syntax element.

In an example, the first syntax element is signaled in a geometry slice header.

In an example, the first geometry coding strategy is one of a polygon fan coding strategy and a dual degree coding strategy.

In an example, when the first geometry coding strategy is the polygon fan coding strategy, a second syntax element for the first group of connected components is decoded. The second syntax element indicates a polygon fan traversal strategy in a plurality of polygon fan traversal strategies. The plurality of polygon fan traversal strategies includes connectivity guided traversal strategy and geometry guided traversal strategy.

In an example, when the first geometry coding strategy is the polygon fan coding strategy and a face type of the first group of connected components is not a triangular face type, a third syntax element for the first group of connected components is decoded. The third syntax element indicates whether the first group of connected components is quad dominated. The first group of connected components is quad dominated when a face degree mode of the first group of connected components and a vertex degree mode of the first group of connected components are equal to 4.

In an example, when the first geometry coding strategy is the dual degree coding strategy, a fourth syntax element for the first group of connected components is decoded. The fourth syntax element indicates a dual degree traversal strategy in a plurality of dual degree traversal strategies.

In an example, when the first geometry coding strategy is the dual degree coding strategy, a fifth syntax element for the first group of connected components is decoded. The fifth syntax element indicates a vertex degree mode of the first group of connected components.

In an example, when the first geometry coding strategy is the dual degree coding strategy, a sixth syntax element for the first group of connected components is decoded. The sixth syntax element indicates whether the first group of connected components includes a dummy face.

At (S1520), the geometry of the first group of connected components is decoded with the first geometry coding strategy. The first geometry coding strategy is different from a second geometry coding strategy for a geometry of a second group of connected components in the plurality of groups of connected components.

Then, the process proceeds to (S1599) and terminates.

The process (1500) can be suitably adapted. Step(s) in the process (1500) can be modified and/or omitted. Additional step(s) can be added. Any suitable order of implementation can be used.

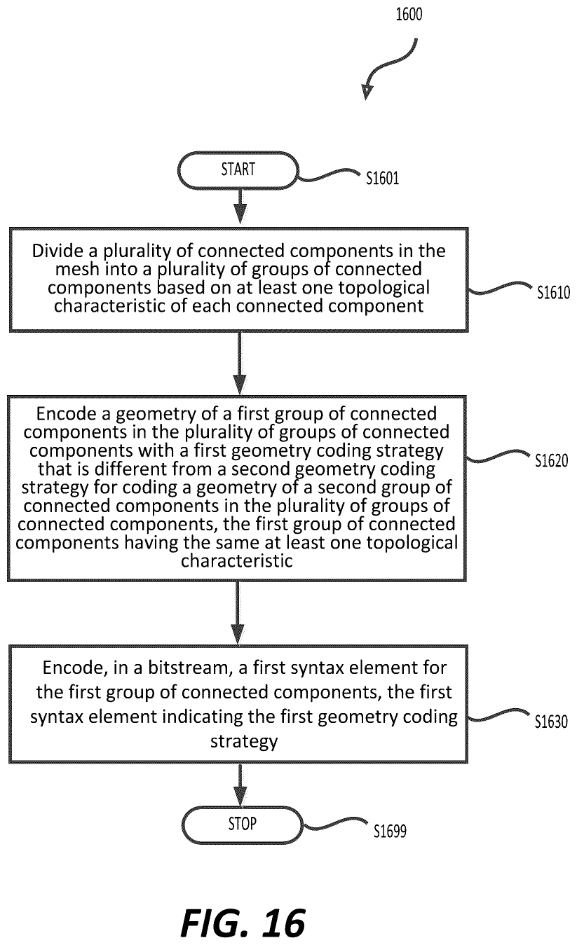

FIG. 16 shows a flow chart outlining a process (1600) according to an aspect of the disclosure. The process (1600) can be used in an apparatus. The apparatus may include a mesh encoder, such as a video encoder. The video encoder is configured to, for example, to encode one or more meshes. In various aspects, the process (1600) is executed by processing circuitry, such as the processing circuitry that performs functions of the video encoder (103), the processing circuitry that performs functions of the video encoder (303), the mesh encoder, and/or the like. In some aspects, the process (1600) is implemented in software instructions, thus when the processing circuitry executes the software instructions, the processing circuitry performs the process (1600). The process starts at (S1601) and proceeds to (S1610).

At (S1610), a plurality of connected components in a mesh is divided (e.g., grouped) into a plurality of groups of connected components based on at least one topological characteristic of each connected component.

In an example, the at least one topological characteristic of each connected component includes one or more of (i) orientability of the respective connected component, (ii) whether the respective connected component is 2-manifold, (iii) whether the respective connected component has a degenerate face, (iv) a face degree mode of the respective connected component, and (v) a vertex degree mode of the respective connected component.

At (S1620), a geometry of a first group of connected components in the plurality of groups of connected components is encoded with a first geometry coding strategy that is different from a second geometry coding strategy for coding a geometry of a second group of connected components in the plurality of groups of connected components. The first group of connected components has the same at least one topological characteristic.

In an example, the first geometry coding strategy is one of a polygon fan coding strategy and a dual degree coding strategy.

At (S1630), a first syntax element for the first group of connected components is encoded in a bitstream. The first syntax element indicates the first geometry coding strategy.

In an example, the first group of connected components is a first slice in the mesh, and the first syntax element is a slice level syntax element.

In an example, the first syntax element is encoded and signaled in a geometry slice header.

In an example, when the first geometry coding strategy is the polygon fan coding strategy, a second syntax element for the first group of connected components is encoded in the bitstream. The second syntax element indicates a polygon fan traversal strategy in a plurality of polygon fan traversal strategies. The plurality of polygon fan traversal strategies includes connectivity guided traversal strategy and geometry guided traversal strategy.

In an example, when the first geometry coding strategy is the polygon fan coding strategy and a face type of the first group of connected components is not a triangular face type, a third syntax element for the first group of connected components is encoded in the bitstream. The third syntax element indicates whether the first group of connected components is quad dominated. The first group of connected components is quad dominated when a face degree mode of the first group of connected components and a vertex degree mode of the first group of connected components are equal to 4.

In an example, when the first geometry coding strategy is the dual degree coding strategy, a fourth syntax element for the first group of connected components is encoded in the bitstream. The fourth syntax element indicates a dual degree traversal strategy in a plurality of dual degree traversal strategies.

In an example, when the first geometry coding strategy is the dual degree coding strategy, a fifth syntax element for the first group of connected components is encoded in the bitstream. The fifth syntax element indicates a vertex degree mode of the first group of connected components.

Then, the process proceeds to (S1699) and terminates.

The process (1600) can be suitably adapted. Step(s) in the process (1600) can be modified and/or omitted. Additional step(s) can be added. Any suitable order of implementation can be used.

In some aspects, the techniques described herein relate to a non-transitory computer-readable storage medium storing instructions which when executed by a processor cause the processor to perform an encoding method comprising: dividing a plurality of connected components in a mesh into a plurality of groups of connected components based on at least one topological characteristic of each connected component; encoding a geometry of a first group of connected components in the plurality of groups of connected components with a first geometry coding strategy that is different from a second geometry coding strategy for coding a geometry of a second group of connected components in the plurality of groups of connected components, the first group of connected components having the same at least one topological characteristic; encoding, in a bitstream, a first syntax element for the first group of connected components, the first syntax element indicating the first geometry coding strategy; and transmitting the bitstream including the first syntax element.

In an aspect, a method of processing a mesh includes processing a bitstream of the mesh according to a format rule. For example, the bitstream is a bitstream that is decoded/encoded in any of the decoding and/or encoding methods described herein. The format rule may specify one or more constraints of the bitstream and/or one or more processes to be performed by the decoder and/or encoder.

In an aspect, the bitstream includes a first syntax element for a first group of connected components of a plurality of groups of connected components. The first syntax element indicates a first geometry coding strategy for coding a geometry of the first group of connected components. The mesh includes a plurality of connected components that is divided into the plurality of groups of connected components based on at least one topological characteristic of each connected component. The first group of connected components has the same at least one topological characteristic. The format rule specifies that the geometry of the first group of connected components is decoded with the first geometry coding strategy that is different from a second geometry coding strategy for a geometry of a second group of connected components in the plurality of groups of connected components.

The methods, aspects, and examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

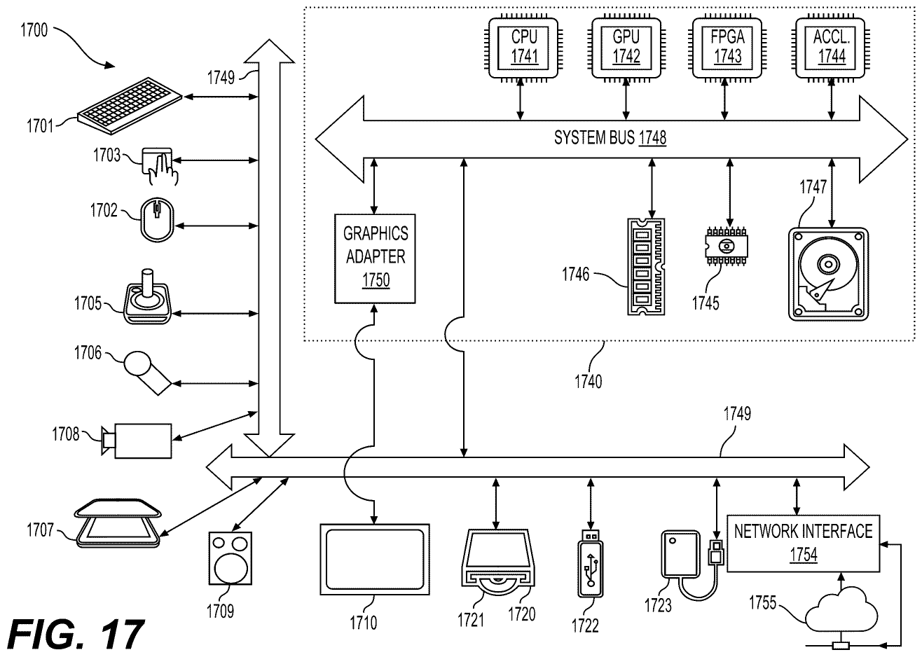

The techniques described above, can be implemented as computer software using computer-readable instructions and physically stored in one or more computer-readable media. For example, FIG. 17 shows a computer system (1700) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 17 for computer system (1700) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1700).

Computer system (1700) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1701), mouse (1702), trackpad (1703), touch screen (1710), data-glove (not shown), joystick (1705), microphone (1706), scanner (1707), camera (1708).

Computer system (1700) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1710), data-glove (not shown), or joystick (1705), but there can also be tactile feedback devices that do not serve as input devices), audio output devices (such as: speakers (1709), headphones (not depicted)), visual output devices (such as screens (1710) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1700) can also include human accessible storage devices and their associated media such as optical media including CD/DVD ROM/RW (1720) with CD/DVD or the like media (1721), thumb-drive (1722), removable hard drive or solid state drive (1723), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1700) can also include an interface (1754) to one or more communication networks (1755). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1749) (such as, for example USB ports of the computer system (1700)); others are commonly integrated into the core of the computer system (1700) by attachment to a system bus as described below (for example Ethernet interface into a PC computer system or cellular network interface into a smartphone computer system). Using any of these networks, computer system (1700) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1740) of the computer system (1700).

The core (1740) can include one or more Central Processing Units (CPU) (1741), Graphics Processing Units (GPU) (1742), specialized programmable processing units in the form of Field Programmable Gate Areas (FPGA) (1743), hardware accelerators for certain tasks (1744), graphics adapters (1750), and so forth. These devices, along with Read-only memory (ROM) (1745), Random-access memory (1746), internal mass storage such as internal non-user accessible hard drives, SSDs, and the like (1747), may be connected through a system bus (1748). In some computer systems, the system bus (1748) can be accessible in the form of one or more physical plugs to enable extensions by additional CPUs, GPU, and the like. The peripheral devices can be attached either directly to the core's system bus (1748), or through a peripheral bus (1749). In an example, the screen (1710) can be connected to the graphics adapter (1750). Architectures for a peripheral bus include PCI, USB, and the like.

CPUs (1741), GPUs (1742), FPGAs (1743), and accelerators (1744) can execute certain instructions that, in combination, can make up the aforementioned computer code. That computer code can be stored in ROM (1745) or RAM (1746). Transitional data can also be stored in RAM (1746), whereas permanent data can be stored for example, in the internal mass storage (1747). Fast storage and retrieve to any of the memory devices can be enabled through the use of cache memory, that can be closely associated with one or more CPU (1741), GPU (1742), mass storage (1747), ROM (1745), RAM (1746), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1700), and specifically the core (1740) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1740) that are of non-transitory nature, such as core-internal mass storage (1747) or ROM (1745). The software implementing various aspects of the present disclosure can be stored in such devices and executed by core (1740). A computer-readable medium can include one or more memory devices or chips, according to particular needs. The software can cause the core (1740) and specifically the processors therein (including CPU, GPU, FPGA, and the like) to execute particular processes or particular parts of particular processes described herein, including defining data structures stored in RAM (1746) and modifying such data structures according to the processes defined by the software. In addition or as an alternative, the computer system can provide functionality as a result of logic hardwired or otherwise embodied in a circuit (for example: accelerator (1744)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method for decoding a mesh, the method including: decoding a first syntax element for a first group of connected components of a plurality of groups of connected components in a bitstream, the first syntax element indicating a first geometry coding strategy for coding a geometry of the first group of connected components, the mesh including a plurality of connected components that is divided into the plurality of groups of connected components based on at least one topological characteristic of each connected component, the first group of connected components having the same at least one topological characteristic; and decoding the geometry of the first group of connected components with the first geometry coding strategy that is different from a second geometry coding strategy for a geometry of a second group of connected components in the plurality of groups of connected components.

(2) The method of feature (1), in which the at least one topological characteristic of each connected component includes one or more of (i) orientability of the respective connected component, (ii) whether the respective connected component is 2-manifold, (iii) whether the respective connected component has a degenerate face, (iv) a face degree mode of the respective connected component, and (v) a vertex degree mode of the respective connected component.

(3) The method of feature (1) or (2), in which the first group of connected components is a first slice in the mesh, and the first syntax element is a slice level syntax element.

(4) The method of feature (3), in which the first syntax element is signaled in a geometry slice header.

(5) The method of any of features (1)-(4), in which the first geometry coding strategy is one of a polygon fan coding strategy and a dual degree coding strategy.

(6) The method of feature (5), further including: when the first geometry coding strategy is the polygon fan coding strategy, decoding a second syntax element for the first group of connected components, the second syntax element indicating a polygon fan traversal strategy in a plurality of polygon fan traversal strategies, the plurality of polygon fan traversal strategies including connectivity guided traversal strategy and geometry guided traversal strategy.

(7) The method of feature (5), further including: when the first geometry coding strategy is the polygon fan coding strategy and a face type of the first group of connected components is not a triangular face type, decoding a third syntax element for the first group of connected components, the third syntax element indicating whether the first group of connected components is quad dominated, the first group of connected components being quad dominated when a face degree mode of the first group of connected components and a vertex degree mode of the first group of connected components are equal to 4.

(8) The method of feature (5), further including: when the first geometry coding strategy is the dual degree coding strategy, decoding a fourth syntax element for the first group of connected components, the fourth syntax element indicating a dual degree traversal strategy in a plurality of dual degree traversal strategies.

(9) The method of feature (5), further including: when the first geometry coding strategy is the dual degree coding strategy, decoding a fifth syntax element for the first group of connected components, the fifth syntax element indicating a vertex degree mode of the first group of connected components.

(10) The method of feature (5), further including: when the first geometry coding strategy is the dual degree coding strategy, decoding a sixth syntax element for the first group of connected components, the sixth syntax element indicating whether the first group of connected components includes a dummy face.

(11) A method for encoding a mesh, the method including: dividing a plurality of connected components in the mesh into a plurality of groups of connected components based on at least one topological characteristic of each connected component; encoding a geometry of a first group of connected components in the plurality of groups of connected components with a first geometry coding strategy that is different from a second geometry coding strategy for coding a geometry of a second group of connected components in the plurality of groups of connected components, the first group of connected components having the same at least one topological characteristic; and encoding, in a bitstream, a first syntax element for the first group of connected components, the first syntax element indicating the first geometry coding strategy.

(12) The method of feature (11), in which the at least one topological characteristic of each connected component includes one or more of (i) orientability of the respective connected component, (ii) whether the respective connected component is 2-manifold, (iii) whether the respective connected component has a degenerate face, (iv) a face degree mode of the respective connected component, and (v) a vertex degree mode of the respective connected component.

(13) The method of feature (11) or (12), in which the first group of connected components is a first slice in the mesh, and the first syntax element is a slice level syntax element.

(14) The method of feature (13), in which the first syntax element is signaled in a geometry slice header.

(15) The method of any of features (11)-(14), in which the first geometry coding strategy is one of a polygon fan coding strategy and a dual degree coding strategy.

(16) The method of feature (15), further including: when the first geometry coding strategy is the polygon fan coding strategy, encoding, in the bitstream, a second syntax element for the first group of connected components, the second syntax element indicating a polygon fan traversal strategy in a plurality of polygon fan traversal strategies, the plurality of polygon fan traversal strategies including connectivity guided traversal strategy and geometry guided traversal strategy.

(17) The method of feature (15), further including: when the first geometry coding strategy is the polygon fan coding strategy and a face type of the first group of connected components is not a triangular face type, encoding, in the bitstream, a third syntax element for the first group of connected components, the third syntax element indicating whether the first group of connected components is quad dominated, the first group of connected components being quad dominated when a face degree mode of the first group of connected components and a vertex degree mode of the first group of connected components are equal to 4.

(18) The method of feature (15), further including: when the first geometry coding strategy is the dual degree coding strategy, encoding, in the bitstream, a fourth syntax element for the first group of connected components, the fourth syntax element indicating a dual degree traversal strategy in a plurality of dual degree traversal strategies.

(19) The method of feature (15), further including: when the first geometry coding strategy is the dual degree coding strategy, encoding, in the bitstream, a fifth syntax element for the first group of connected components, the fifth syntax element indicating a vertex degree mode of the first group of connected components.

(20) A non-transitory computer-readable storage medium storing instructions which when executed by a processor cause the processor to perform an encoding method comprising: dividing a plurality of connected components in a mesh into a plurality of groups of connected components based on at least one topological characteristic of each connected component; encoding a geometry of a first group of connected components in the plurality of groups of connected components with a first geometry coding strategy that is different from a second geometry coding strategy for coding a geometry of a second group of connected components in the plurality of groups of connected components, the first group of connected components having the same at least one topological characteristic; encoding, in a bitstream, a first syntax element for the first group of connected components, the first syntax element indicating the first geometry coding strategy; and transmitting the bitstream including the first syntax element.

(21) An apparatus for video decoding, including processing circuitry that is configured to perform the method of any of features (1) to (10).

(22) An apparatus for video encoding, including processing circuitry that is configured to perform the method of any of features (11) to (19).

(23) A non-transitory computer-readable storage medium storing instructions which when executed by at least one processor cause the at least one processor to perform the method of any of features (1) to (19).

What is claimed is:

1. A method for decoding a mesh, the method comprising:
decoding a first syntax element for a first group of connected components of a plurality of groups of connected components in a bitstream, the first syntax element indicating a first geometry coding strategy for coding a geometry of the first group of connected components, the mesh including a plurality of connected components that is divided into the plurality of groups of connected components based on at least one topological characteristic of each connected component, the first group of connected components having the same at least one topological characteristic; and
decoding the geometry of the first group of connected components with the first geometry coding strategy that is different from a second geometry coding strategy for a geometry of a second group of connected components in the plurality of groups of connected components.

2. The method of claim 1, wherein the at least one topological characteristic of each connected component includes one or more of (i) orientability of the respective connected component, (ii) whether the respective connected component is 2-manifold, (iii) whether the respective connected component has a degenerate face, (iv) a face degree mode of the respective connected component, and (v) a vertex degree mode of the respective connected component.

3. The method of claim 1, wherein the first group of connected components is a first slice in the mesh, and the first syntax element is a slice level syntax element.

4. The method of claim 3, wherein the first syntax element is signaled in a geometry slice header.

5. The method of claim 1, wherein the first geometry coding strategy is one of a polygon fan coding strategy and a dual degree coding strategy.

6. The method of claim 5, further comprising:
when the first geometry coding strategy is the polygon fan coding strategy, decoding a second syntax element for the first group of connected components, the second syntax element indicating a polygon fan traversal strategy in a plurality of polygon fan traversal strategies, the plurality of polygon fan traversal strategies including connectivity guided traversal strategy and geometry guided traversal strategy.

7. The method of claim 5, further comprising:
when the first geometry coding strategy is the polygon fan coding strategy and a face type of the first group of connected components is not a triangular face type, decoding a third syntax element for the first group of connected components, the third syntax element indicating whether the first group of connected components is quad dominated, the first group of connected components being quad dominated when a face degree mode of the first group of connected components and a vertex degree mode of the first group of connected components are equal to 4.

8. The method of claim 5, further comprising:
when the first geometry coding strategy is the dual degree coding strategy, decoding a fourth syntax element for the first group of connected components, the fourth syntax element indicating a dual degree traversal strategy in a plurality of dual degree traversal strategies.

9. The method of claim 5, further comprising:
when the first geometry coding strategy is the dual degree coding strategy, decoding a fifth syntax element for the first group of connected components, the fifth syntax element indicating a vertex degree mode of the first group of connected components.

10. The method of claim 5, further comprising:
when the first geometry coding strategy is the dual degree coding strategy, decoding a sixth syntax element for the first group of connected components, the sixth syntax element indicating whether the first group of connected components includes a dummy face.

11. A method for encoding a mesh, the method comprising:
dividing a plurality of connected components in the mesh into a plurality of groups of connected components based on at least one topological characteristic of each connected component;
encoding a geometry of a first group of connected components in the plurality of groups of connected components with a first geometry coding strategy that is different from a second geometry coding strategy for coding a geometry of a second group of connected components in the plurality of groups of connected components, the first group of connected components having the same at least one topological characteristic; and
encoding, in a bitstream, a first syntax element for the first group of connected components, the first syntax element indicating the first geometry coding strategy.

12. The method of claim 11, wherein the at least one topological characteristic of each connected component includes one or more of (i) orientability of the respective connected component, (ii) whether the respective connected component is 2-manifold, (iii) whether the respective connected component has a degenerate face, (iv) a face degree mode of the respective connected component, and (v) a vertex degree mode of the respective connected component.

13. The method of claim 11, wherein the first group of connected components is a first slice in the mesh, and the first syntax element is a slice level syntax element.

14. The method of claim 13, wherein the first syntax element is signaled in a geometry slice header.

15. The method of claim 11, wherein the first geometry coding strategy is one of a polygon fan coding strategy and a dual degree coding strategy.

16. The method of claim 15, further comprising:
when the first geometry coding strategy is the polygon fan coding strategy, encoding, in the bitstream, a second syntax element for the first group of connected components, the second syntax element indicating a polygon fan traversal strategy in a plurality of polygon fan traversal strategies, the plurality of polygon fan traversal strategies including connectivity guided traversal strategy and geometry guided traversal strategy.

17. The method of claim 15, further comprising:
when the first geometry coding strategy is the polygon fan coding strategy and a face type of the first group of connected components is not a triangular face type, encoding, in the bitstream, a third syntax element for the first group of connected components, the third syntax element indicating whether the first group of connected components is quad dominated, the first group of connected components being quad dominated when a face degree mode of the first group of connected components and a vertex degree mode of the first group of connected components are equal to 4.

18. The method of claim 15, further comprising:
when the first geometry coding strategy is the dual degree coding strategy, encoding, in the bitstream, a fourth syntax element for the first group of connected components, the fourth syntax element indicating a dual degree traversal strategy in a plurality of dual degree traversal strategies.

19. The method of claim 15, further comprising:
when the first geometry coding strategy is the dual degree coding strategy, encoding, in the bitstream, a fifth syntax element for the first group of connected components, the fifth syntax element indicating a vertex degree mode of the first group of connected components.

20. A non-transitory computer-readable storage medium storing instructions which when executed by a processor cause the processor to perform an encoding method comprising:
dividing a plurality of connected components in a mesh into a plurality of groups of connected components based on at least one topological characteristic of each connected component;
encoding a geometry of a first group of connected components in the plurality of groups of connected components with a first geometry coding strategy that is different from a second geometry coding strategy for coding a geometry of a second group of connected components in the plurality of groups of connected components, the first group of connected components having the same at least one topological characteristic;
encoding, in a bitstream, a first syntax element for the first group of connected components, the first syntax element indicating the first geometry coding strategy; and
transmitting the bitstream including the first syntax element.
